(19) United States
(12) Patent Application Publication
(10) Pub. No.: US 2006/0064201 A1
(43) Pub. Date: Mar. 23, 2006

(54) Method and apparatus for controlling a vending machine

(76) Inventor: Munroe Chirnomas, Morris Township, NJ (US)

Correspondence Address: LAWRENCE C. EDELMAN, IP COUNSEL FASTCORP, 60 E. HANOVER AVE, B-2, MORRIS PLAINS, NJ, 07950, US

(21) Appl. No.: 11/267,352

(22) Filed: Nov. 4, 2005

Related U.S. Application Data
(63) Continuation of application No. 10/296,566, filed on Nov. 23, 2002.

(51) Int. Cl. G06F 17/00

(52) U.S. Cl. 700/242

(57) ABSTRACT

A vending apparatus including a control system for dispensing articles, including one or more of the following features: 1. an article ID device which can identify articles being dispensed from the apparatus; 2. ability to disable dispensing of at least some of the articles stored therein, in a predetermined fashion, without the need for any communication or any disable code being input thereto external from the apparatus or its control system; 3. ability to re-enable dispensing of articles when an authorization code is received and input into the control system of the apparatus. In another aspect of the invention, relevant parameters in the control system are pre-programmed (and can be adjusted, changed or eliminated) by an authorized party, in order to enforce agreements and rules that govern operation of the vending apparatus. For example: 1. determining the types of articles which are authorized to be dispensed, 2. adjusting the parameters which determine when or how the apparatus is partially or fully disabled, and k 3. adjusting the programming in the control system to allow a apparatus to disable based on time intervals, or the amount of product sold, etc.

### CROSS-REFERENCE TO RELATED APPLICATIONS

This application is a continuation application of and claims priority under 35 USC 120 of U.S. application Ser. No. 10/296,566, filed Nov. 23, 2002, which is a U.S. national phase designation of PCT application PCT/US01/16,837 filed May 23, 2001, the contents of which are expressly incorporated herein by this reference thereto.

The following description comprises three parts.

Part I describes a vending machine apparatus and details thereof, useful for understanding methods and apparatus in accordance with the principles of the present invention,

Part II describes methods and apparatus in accordance with the principles of the present invention, for controlling a vending machine of the type described in Part I, and

Part III provides further description of the methods and apparatus in accordance with the principles of the present invention.

### PART I

### FIELD OF THE INVENTION

The present invention relates generally to improvements in the design, operation, and use of article handling apparatus and in particular to article handling apparatus of the type which utilize computer-controlled electromechanical technology for grasping and moving a selected article from one area to another, such as from a storage area to a dispensing area of a vending apparatus.

### BRIEF DESCRIPTION OF THE FIGURES

FIG. 1 is a front perspective view of a vending machine constructed and operating in accordance with the principles of the invention, and useful for carrying out the methods described in Part II of this description.

FIGS. 2 and 3 are front perspective views of the vending machine of FIG. 1, with the front door opened, so as to illustrate the main mechanical and electrical components therein.

FIG. 4 is a functional block diagram illustrating the cooperation of the main mechanical and electrical components in the vending machine of FIG. 1.

FIGS. 5 and 6 illustrate details of the carriage portion of article handling mechanism shown in FIGS. 2 and 3.

FIG. 7 illustrates details of the hose guidance mechanism shown in FIGS. 2 and 3.

FIG. 8 illustrates an alternative embodiment of the hose positioning mechanism shown in FIG. 3.

FIGS. 9, 10, 11, 12 and 13 illustrate combinations/orientations of various article handling mechanisms and storage areas.

FIGS. 14 though 27 are various illustrations of the methods of operation described in Parts II and III, for a vending machine as described in Part I, as well as business relationships which can benefit from and utilize a vending machine having the features of the present invention.

### DETAILED DESCRIPTION OF THE PREFERRED EMBODIMENTS

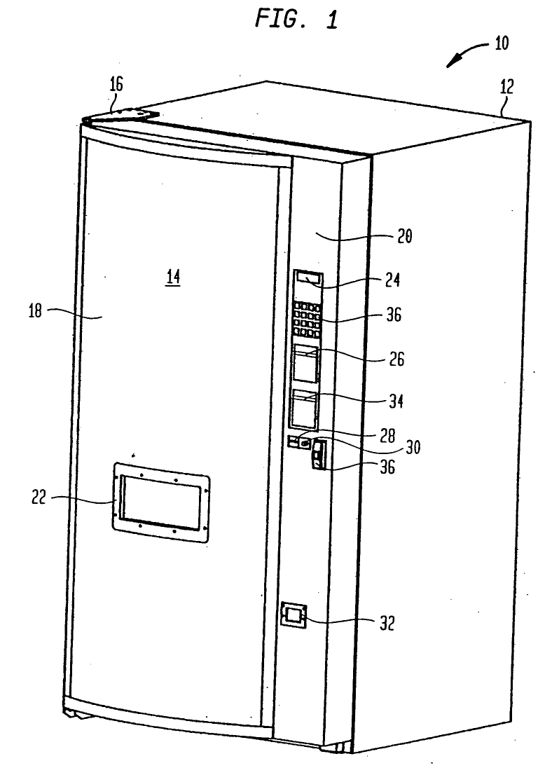

FIG. 1 illustrates an environment for the invention described herein, in the form of an article dispenser, such as a point-of-sale (POS) dispenser. Although throughout the following description, reference is made to implementation of the invention in a vending machine environment, it is intended that the term “vending machine”, and in fact the environment for the present invention, include more general purpose article handling, retrieval and/or dispensing apparatus, as well as POS equipment. Such equipment, if embodied as a portable device may comprise and be about the size of a traditional vending machine or as large as a tractor-pulled trailer, and if embodied as a non-portable device may comprise and be embodied as an automated dispensing room or an area located in a permanent structure, such as in a building (aboveground or underground, and with or without interior walls or an enclosing cabinet). Furthermore, it is intended that the term “articles” or “products” include in at least some of the embodiments of the invention described herein, not only goods, but also services and/or information, in either a permanent or temporal form.

Accordingly, FIG. 1 illustrates a perspective view of a vending machine 10, comprising one embodiment for an apparatus which is constructed and operates according to the present invention. Vending machine 10 includes a main cabinet 12 and a front door 14 mounted on a hinge 16 for providing access to the interior of the vending machine for servicing (filling it with articles, maintenance, etc.). Note, in a further vending machine embodiment, a service door or port could be positioned anywhere on or as a part of cabinet 12. In FIG. 1, front door 14 is shown in a closed position, forming an enclosure with main cabinet 12, within which various components of vending machine 10 are housed, as explained in more detail below.

Front door 14 includes a convex-shaped section 18 adjacent a flat section 20; however, these particular shapes are not necessary to the invention. The convex-shaped section 18 comprises a translucent plastic display panel 18, which typically has brand name and/or logo graphics displayed thereon, and may even include graphics which illustrate the individual articles that are vendible by vending machine 10, as well as the price and/or selection information for the articles. Panel 18 is typically back-light using fluorescent bulbs, not shown.

A customer retrieval area 22 is formed in the panel 18 on door 14 so that articles stored therein can be discharged to a user of vending machine 10.

Various user interface features are mounted on flat section 20 of door 14. A customer display 24 may be a conventional fluorescent or LED display panel for displaying various items of information to a user of machine 10, such as feedback to the user of the selection made, the amount tended, and if the product is sold out or being vended. For accepting payments, a bill acceptor slot 26 accepts paper money into a conventional bill acceptor mechanism (mounted inside machine 10 so as to have its user interface portion extend through an aligned opening in flat section 20) for purchasing articles or for making change. A coin insertion slot 28 accepts coins into a conventional coin changer (also mounted inside machine 10 so as to have its user interface portion extend through an aligned opening in flat section 20) for purchasing articles or for making change. A coin return actuator 30 comprises a conventional push-button mechanism for activating a coin return portion of the coin changer mechanism which, upon actuation returns coins inserted by the current user, to a coin return well 32. The coin return portion of the coin changer mechanism also provides change to the coin return well 32 either in response to the purchasing of articles or for making change for paper money or larger coins. A credit/debit card slot 34 accepts a plastic credit/debit card inserted into a conventional card reader mechanism (also mounted inside machine 10 so as to have its user interface portion extend through an aligned opening in flat section 20) for allowing a user to pay for purchases via credit/debit cards. A door lock mechanism 36 enables front door 14 to be secured so that it cannot be opened without a key. For allowing user selections, display panel 18 may include graphics, as noted above, which indicates the various articles vendible by the machine, as well as their associated price and unique selection number. Alternatively, flat section 20 could include a group of graphic article displays and their associated price. A conventional keypad push-button mechanism 38 is provided for enabling a user to select a desired article from vending machine 10. Alternatively, push-button mechanism 40 could include individual push buttons for each article selection, as well as an associated price display, and even furthermore, a user operated touch screen could replace pushbutton mechanism 40 and display 24. Although not shown in FIG. 1, machine 10 also includes a conventional telecommunications component that can be used for authenticating credit card purchases, as well as other uses relating to machine control and reporting the inventory and operational status of machine 10 to a remote location, as more fully described later on. Although vending machine 10 is illustrated to include the above described user interface components, in a more minimal embodiment of the invention, most, if not all, of these user interface components could be omitted, and the dispenser could in fact be controlled from a remote location, with or without a local payment system.

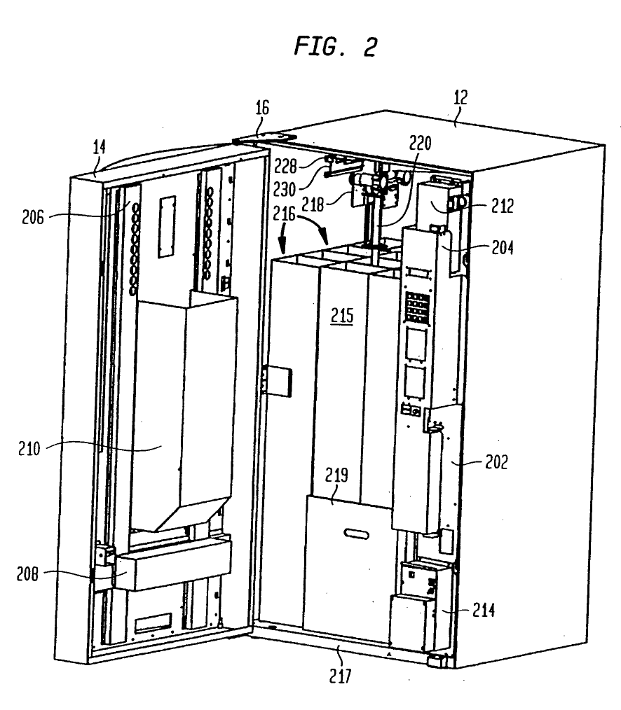

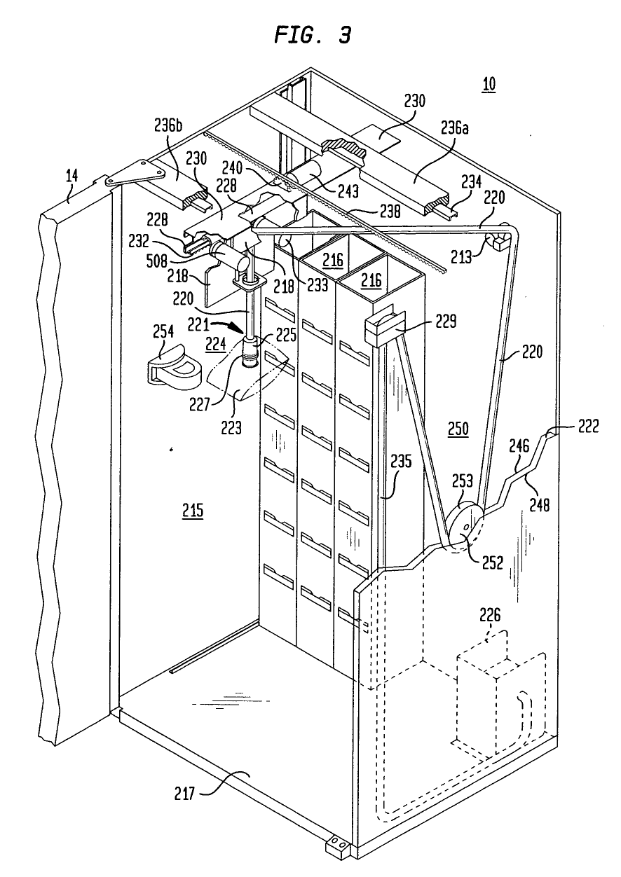

FIG. 2 is a front perspective view of the vending machine of FIG. 1, with the front door open, so as to illustrate the main mechanical and electrical components therein. FIG. 3 is a somewhat idealized version of the main components of the article handling mechanism portion of vending machine 10, and is useful for understanding its general operation. Note, some portions of vending machine 10 are shown in these FIGURES cut away in order to better illustrate the interior components.

Referring first to FIG. 2, it is noted that the right portion of the front of cabinet 12 includes a vertically mounted support panel 202 which is used for mounting most of the user interface components. More specifically, a hinged mounting bracket 204 is mounted on panel 202 and aligned with an opening in door 14 so that the user interface components, such as the selection button keypad 40, coin insertion slot 30, bill acceptor slot 28, coin return 32, and customer display 24, are all accessible to the user from the front side of door 14. Mounted on the interior of front door 14 are two fluorescent bulb light sources (which are behind protective covers 206. Other numbers of light sources can be used) which emit light for backlighting panel 18. A ballast 208 for the fluorescent bulbs and a product delivery chute 210. Note, the product delivery chute 210 is unconventional in that it is extremely tall, and therefore serves as a security measure to prevent unauthorized access into the machine by insertion of an arm or other grasping mechanism into the customer retrieval area 22 from outside the machine. In typical prior art vending machines, a swinging security door is usually found at the top of chute 210, which swings into a vandal blocking position when the customer pushes in the swinging door at the entrance to the product retrieval area 8. In a further embodiment of vending machine 10, such a security door could be used in conjunction with product delivery chute 210, especially if chute 210 is not as tall as the one illustrated in FIG. 2 and also if the product retrieval area 8 is located higher up on machine 10. Mounted behind hinged mounting bracket 204 is a conventional bill acceptor mechanism for causing paper money inserted into bill acceptor slot 28 to be drawn into vending machine 10, a conventional coin changer supplies coins to coin return slot 34 and is located behind panel, a coin guide guides inserted coins into the coin changer, and a conventional bill validator ascertains proper insertion of paper money into bill acceptor slot 28.

A control board 212 comprises a printed circuit board on which circuitry is formed and to which integrated circuit chips are attached. Control board 212 includes a microprocessor that is electrically connected to various sensors, motors, the above described user interface elements, as well as other devices within vending machine 10, to control the operation of vending machine 10 as described herein. When reference is made in this description to performance of specified functions by control board 212, it is to be understood that these functions are controlled by the microprocessor and the associated circuitry formed on control board 212. A power supply 214 is mounted on panel 202 and supplies power for the electrical components of vending machine 10.

Referring now also to FIG. 3, it is apparent that the bulk of the interior of cabinet 12 is available as an article storage area 215. In the illustrated embodiment, a plurality of vertically aligned article storage bins 216 are arranged on the interior floor 217 of cabinet 12, for storing articles 223 to be vended by machine 10. In a refrigerated environment for the present invention the bins could be arranged to sit on a shelf positioned above the refrigeration system.

An opened-top container 219 can be dimensioned to hold a plurality of article storage bins 216 therein, and used, for example to facilitate the simultaneous handling (i.e., removal installation and transportation) of the plurality of bins 216 into/out of the article storage area 215. Container 219 also facilitates rapid and accurate positioning of a plurality of the article storage bins into the storage area of the article handling apparatus. A carriage 218 (which may be more generally referred to as an X-Y or planar positioning mechanism) is coupled to the interior topside of cabinet 12 and adapted for being controllably positioned by the control board portion 212 of machine 10, to a location centered over (so as to be aligned with) the open top-end of a selected one of article storage bins 216.

Although vertical (Z-axis) alignment of the article storage bins 216 is shown, non-vertical, i.e., slanted or even horizontal (X or Y axis) alignment may also be possible (such as found in the well know glass front vending machines of the type using a “spiral wire” type of dispensing apparatus). In the event of substantially horizontal alignment of the storage bins, the planar positioning mechanism will be appropriate changed so as to position carriage 218 for movement in the X/Z or Y/Z plane. In fact, a curvilinear plane, such as a cylinder, is also considered to be within the scope of the present invention. The combination of substantially horizontally aligned stacks of products with a robotically controlled article transport mechanism which moves in a vertical plane adjacent to dispensing ends of the stacks of products, is known, for example in U.S. Pat. No. 6,230,930 issued May 15, 2001 and entitled METHOD AND APPARATUS FOR VENDING PRODUCTS, and in US patent publication US 2001/0000609 published May 3, 2001. Use of a curvilinear plane for article transport is known, for example in the videocassette vending art, wherein the videocassette's are stacked in an outwardly facing manner in a central storage carousel, and a robotic gripper encircles the carousel. Furthermore, although article storage bins 216 are shown to be an ambient environment, bins 216 could in fact the positioned in a refrigerated environment, such as a freezer located in the bottom of storage area 217, and the article transport mechanism enter the bins from a top opening the freezer, such as shown and described in the forenoted U.S. Pat. No. 5,240,139. Alternatively, in the event the refrigerated environment is of the type including a substantially horizontal alignment of the storage bins, a vertically oriented opening could be used to provide access to the dispensing end of the article storage bins.

In the environment of the present invention, an air hose 220 is continuous from a point before it's exit from a hose storage area 222 over orthogonally positioned rollers 213, to its free end 221. Free end 221 includes a weighted portion 225 in combination with a bellows extension tip portion 227. Depending upon the physical characteristics of the articles to be dispensed, article pickup head 224 may comprise only the weighted portion 225, or this portion in combination with a fitting specifically adapted to the type of packages to be dispensed, such as the bellows tip 227 or a compliant tip without a weight. Hose 220 has one end coupled to a source of negative air pressure, i.e., suction, which source of suction comprises in the preferred embodiment a blower motor 226, and a free end coupled to the article pickup head 224. In the present invention, the word continuous is intended to mean a hose which is connected and acts between it's end points, in order to accomplish the functions required by it, as a unitary/single hose. An air hose portion 235 provides suction from blower motor 226 to one port of an air junction box 229, while continuous hose 220 is connected to a second port of air junction box 229. Air junction box 229, included at a top portion of hose storage area 222, includes an airflow sensor and vacuum breaker assembly. The airflow sensor is used to develop a signal which is applied to the controller of the vending machine and is representative of the airflow through air hose 220. The vacuum breaker assembly is used to quickly bring the air pressure in hose 220 to the ambient pressure, thereby facilitating a “quick-release” of an article transported by the article pickup head, into the dispensing chute 210. It is noted that a quick release of the products does not have to occur at the top of dispensing chute 210, and in the event that it is desirable to avoid subjecting the article to forces which result from jarring or dropping, the article pickup head could proceed to the bottom of the dispensing chute 210 before providing the quick release of the article. In one embodiment, the airflow sensor arrangement may comprises a two-part switch, a first part includes a reed switch mounted on a top portion of box 229, and a second part includes a magnet mounted at the free end of a swinging arm mounted inside box 229. As the arm swings inside box 229 due to changes in airflow, the switch is “toggled”, thereby indicating changes in airflow. The use of this airflow signal will be described in greater detail later.

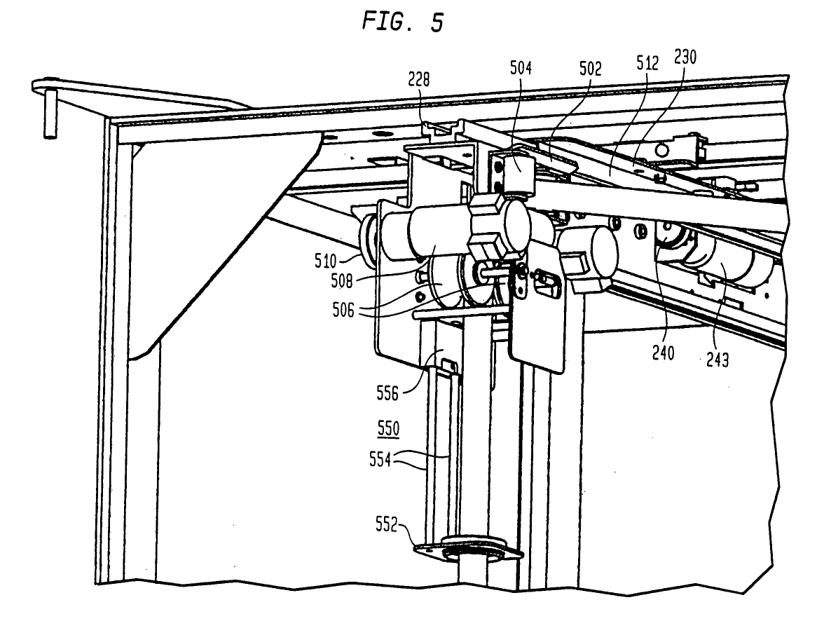

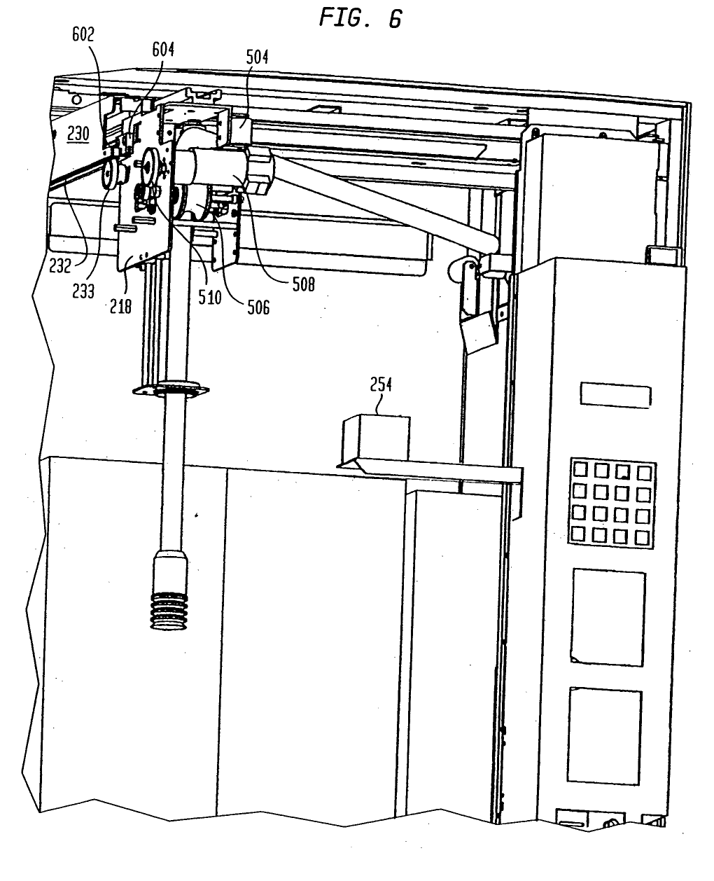

In accordance with one aspect of the present invention, a novel hose positioning arrangement is provided. As shown generally in FIG. 3, and more specifically in FIGS. 5 and 6, alignment of carriage 218 with a selected one of bins 216 is accomplished in the front/back (Y) direction using a front/back linear slide 228 (shown in a cut away view) mounted to an “L” shaped front/back beam 230 so that carriage 218 can be controllably positioned therealong using slide 228. A bottom edge portion of beam 230 includes a rack portion 232 and carriage 218 includes an electric motor 233 that drives a gear (633 of FIG. 6) which engages rack portion 232. Application of forward and reverse motor control signals from control board 212 to motor 233 causes carriage 218 to be driven in the front/back directions. Alignment of carriage 218 in the left/right (X) direction is accomplished in a similar manner, using a left/right linear slide 234 which slidably couples the top side of front/back beam 230 to the underside of each of spaced apart left/right beams 236a and 236b. Beams 236a and 236b are rigidly attached to the inside top portion of cabinet 12. A rack 238, also rigidly attached to the top inside portion of cabinet 12 and in parallel with beams 236, is engaged by a gear 240 driven by a reversible motor 243 mounted near the inside corner of beam 230. Application of forward and reverse motor control signals from control board 212 to motor 243 causes a rotation of gear 240 and a corresponding movement of beam 230, and hence carriage 218, in the left/right (X) directions.

In accordance with a further aspect of the present invention, as the hose positioning arrangement causes an article 223 to be moved by pickup head 224 from a storage bin 216 to chute 210, it is positioned past an article identification (ID) device 254 mounted within cabinet 12. A specific type of article ID device is not required for the present invention, and depending upon system constraints, such a device may comprise, for example, a bar code scanner or other optical image/pattern recognition system, or even a non-optical system, such as a radio frequency identification (RFID), or magnetic-based system mounted within cabinet 12 for uniquely identifying and confirming that the article being dispensed is in fact the article that was selected. The construction operation of such article identification devices are well known to those of ordinary skill in this technology, and therefore further description in this regard is not necessary.

It is noted that article ID device 254 is mounted within cabinet 12 at a relatively fixed location, the mounting being such that some controlled movement in the orientation of article ID device 254 may be facilitated, in order to help ensure a good “view” of the article being transported, and a high confidence of the transported articles being identified. One way to provide such controlled movement for ID device 254 would be to mount it on a piezoelectric substrate, and control board 212 could provide a voltage to the substrate so as to shift the “view” of ID device 254. It is noted that by using an appropriately positioned article ID device 254, only a single article ID device 254 is needed. This is particularly useful for a robotic type dispenser, since the robotic apparatus can controllably position, and re-position if necessary, the article in the vicinity of the article ID device 254, thereby helping ensure a reliable ID of the article.

A bin holder 260, shown in FIG. 2, comprising a pair of rectangular brackets secured in a spaced manner to opposed interior side walls of cabinet 12, is used to maintain the bins situated therebetween in a predetermined position relative to the interior of the vending machine cabinet. This is required in view of the pre-programming of control board 212 which controls the robotic structure for retrieving a selected article from one a selected one of bins 216.

Note that although carriage assembly 218 only moves in a single plane, it is responsible for precisely positioning pickup head 224 in each of the X, Y and Z directions. More specifically, in accordance with a further aspect of the invention as shown in FIGS. 5 and 6, in a preferred embodiment, the hose positioning carriage 218 includes a roller arrangement 502 which comprises three orthogonally positioned rollers 504 at the point where hose 220 enters carriage 218, for redirecting the movement of hose 220 from a substantially horizontal direction along the top interior portion of machine 10 (i.e., in the X,Y direction), to a direction perpendicular thereto (i.e., in the Z direction). Movement of carriage 218 will not only move the free end 221 of hose 220 so that it can be axially aligned with a selected one of bins 216, but it will also automatically withdraw hose 220 from the hose storage area 222. Thereafter, a hose drive mechanism which may comprise a set of conventionally operated “pinch rollers” 506 driven by a reversible motor 508 via gear set 510, which in the illustrated embodiment are mounted in carriage 218, but in a further embodiment motor 508/rollers 506 (or some other drive mechanism, such as the one shown from the forenoted PCT publication WO 99/12132) could be mounted somewhere else along the length of hose 220, are used for driving pickup head 224 into/out of the selected bin 216 in order to retrieve articles stored therein. The event that hose 220 includes structural spiral corrugations along its length, pinch rollers 506 could include matching corrugations thereon for assisting the driving of hose 220.

This arrangement, where hose 220 travels in the same X,Y plane that carriage 218 travels, facilitates a compact hose positioning and drive mechanism embodiment for the present invention. Furthermore, since movement of the carriage is responsible for supplying most of the force needed to withdraw hose 220 from storage area 222, the Z drive motor is only needed to drive the hose for causing its free end to travel into/out of bins 216 for article retrieval. It is noted that the pinch rollers 506 should comprise a soft rubber material so as to provide a good friction contact to hose 220, and if hose 220 includes structural spiral corrugations along its length, pinch rollers 506 could include matching corrugations for providing a more positive driving force to hose 220. In the illustrated embodiment, it has been determined that two drive rollers are not needed, and accordingly only one of the pinch rollers is driven by motor 508, while a spring (514) is used to urge the other roller towards the driven roller, thereby pinching and driving hose 220 therebetween. Furthermore when using corrugated hose, in some applications it may be possible to replace pinch rollers 506 with a linear screw mechanism adjacent hose 220, for driving the hose.

In the vending machine environment, having a compact hose positioning and drive mechanism is significant. The present arrangement of inventive features provides a very compact robotic structure which maximizes the ability of the carriage to position the hose within the interior of cabinet 4. Additionally a compact robotic structure maximizes the article storage capacity of vending machine 10 and increases the ability of the robotic positioner to maneuver within the maximized storage area. Consider a cabinet having a height of 72 inches: a prior art hose positioning mechanism, such as provided by the forenoted U.S. Pat. No. 5,240,139 or the PCT patent publication WO 99/12132 typically occupied approximately 40 percent of the height dimension inside the cabinet, thereby leaving 60 percent or less for the storage of articles to be vended. With the arrangement of the present invention the hose positioning and drive mechanism comprises less than 25 percent of the interior height of the enclosure, a very desirable result. Additionally, it is noted that the compact hose positioning and drive mechanism of the present invention is extraordinary in that in the illustrated embodiment it occupies approximately only 15 percent of the interior height of the enclosure. What is even more remarkable is that this very compact hose positioning and drive mechanism can position the free end of the hose into alignment with a bin of articles, and then have the ability to drive the hose all way to the bottom of the bin. In the present invention the hose is able to be driven a distance which is greater than three times the height of the hose positioning mechanism and in fact, in the illustrated embodiment the hose is driven approximately five times the height of the hose positioning mechanism.

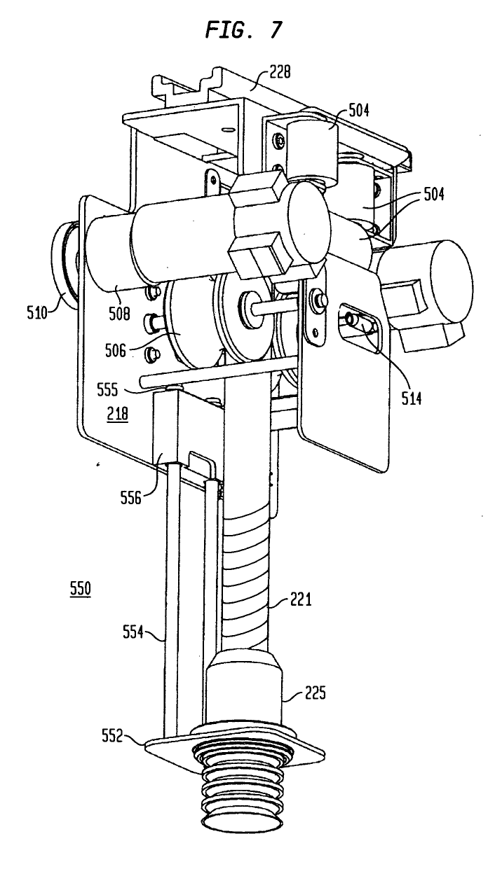

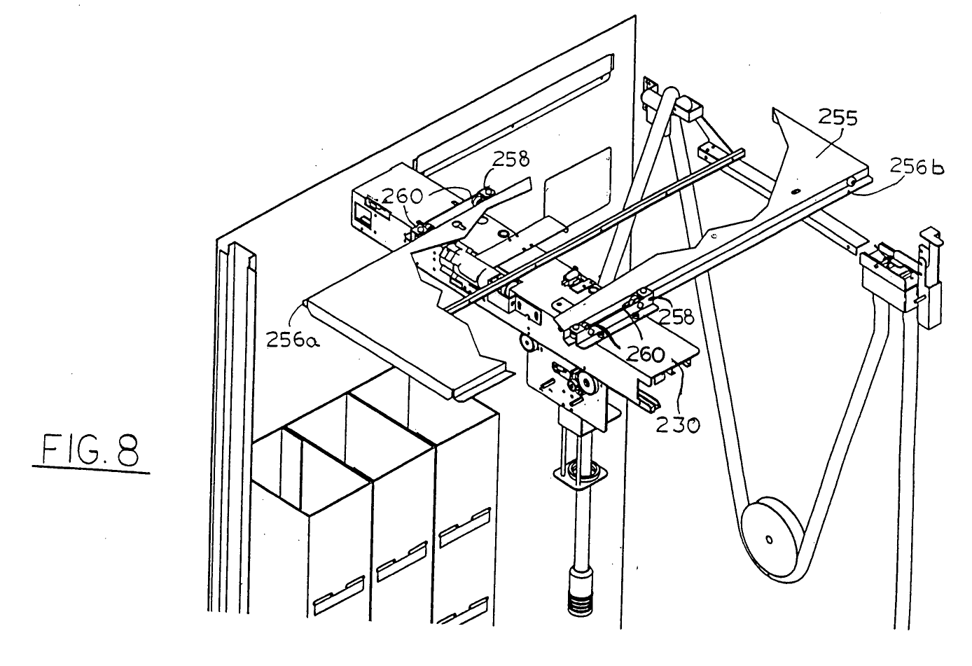

Also shown in FIGS. 5, 6 and FIG. 7, is a telescoping guide mechanism 550 for ensuring that when picker head 224 is lowered by the drive mechanism in carriage 218 into the storage area, it drops into the desired one of bins 216. For example, depending upon the material used for constructing hose 220, it is possible that during long time periods when hose 220 is not repositioned, the 90° turn in the direction of the hose which takes place in carriage 218 can form a significant “kink” in hose 220. Thereafter, as hose 220 is lowered into a selected bin 216, the kink may cause picker head 224 to swing as the hose kink moves past drive rollers 506. In order to prevent such undesired swinging or movements of picker head 224, guide mechanism 550 is provided and comprises a guide plate 552 affixed to the end of two sliding support bars 554. As shown more clearly in FIG. 7, support bars 554 slide through holes in a plastic (PVC, i.e., poly vinyl chloride) block 556 secured to a wall portion of carriage 218. Plate 552 is constructed so as to have a hole in the center thereof which is dimensioned to be slightly greater than the diameter of the body portion of picker head 224, yet less than the diameter of a shoulder portion thereof. Accordingly, in operation when picker head 224 is lowered into a desired bin, support rods 554 allow support plate 552 to drop, due to gravity, as the same speed as picker head 224 is lowered away from carriage 218. At a height above the top of bins 216, and as determined by the length of support rods 554, plate 552 no longer moves away from carriage 218 and the hole in the center thereof merely provides guidance for the remainder of the descent of picker head 224 into the selected bin 216. As picker head 224 is retracted from the bin, after having a package secured thereto due to the suction force created within hose 220, picker head 224 eventually contacts guide plate 552 and then for the remainder of its upward travel, retraction of hose 220 also provides for retraction of guide plate 552.

As also shown in FIGS. 5 and 6, the movement of carriage 218 is somewhat stabilized by the cooperative action of a bracket 512, positioned on the underside of a top portion of support beam 230 through which slide 228 is constrained to follow, and a “U” shaped lip portion 602 which protrudes from a lower side portion of support beam 230. An upwardly pointing portion of the lip 602 is engaged (and in fact “trapped”) by a downward facing slot a slide mechanism 604 attached to carriage 218. It is believed that the cooperative action of the diagonally opposed supports provided by the combinations of bracket 512 and slide 228, as well as lip 602 and slide 604, which are fixed to the two legs of “L” shaped support beam 230, provides for superior stability of carriage 218 during its travel along beam 230.

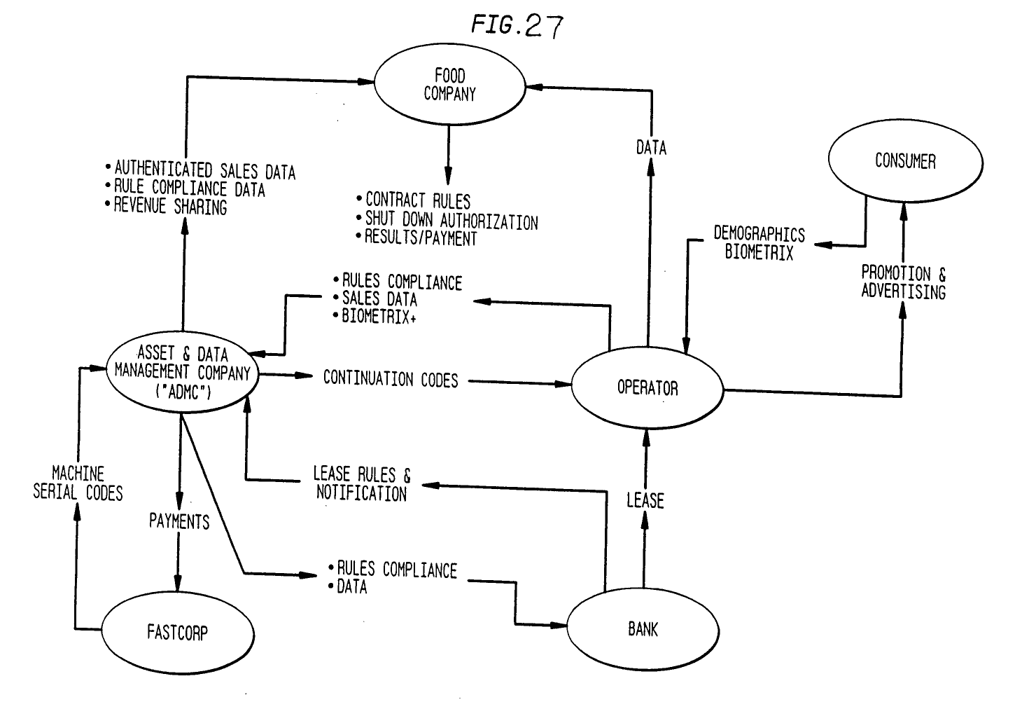

As shown more clearly in FIG. 7, support rods 554 comprise rods having a threaded hole at each end, in which a machine screw can be inserted. At the top portion of rods 554 the head 555 of the screw forms a shoulder portion that prevents rods 554 from falling completely through the holes in block 556, and at the bottom of rods 554 the screws secure plate 552 to the rods. As also shown in FIG. 14b, plate 552 includes a protective grommet about the hole therein, for preventing damage and reducing wear of hose 220 as it travels through plate 552. It is noted that the height of the grommet is preferably greater than the spacing between adjacent turns of the spiral support structure of hose 220. Furthermore, it is noted that hose 220 is preferable constructed of a strong, flexible spiral portion functioning as the spine to form the shape of the hose, formed co-extensively with a flexible and air-tight plastic material which spans adjacent turns of the spiral portion.

Alternative constructions for guide mechanism 132 are also contemplated. For example, a series of telescoping tubing sections, attached to the underside of carriage 218, and through which hose 220 passes, could be used in place of rods 136 and plate 134.

As previously noted, since hose 220 is formed of a continuous material from its connection to the source of suction at one end to the pickup head 224 at its other end, means are necessary for providing hose storage and/or retraction during travel of the pickup head 224 in the X, Y and Z directions, as appropriate during the article dispensing operations.

Accordingly, as shown in FIG. 3, placing an interior wall 246 parallel and adjacent to an exterior wall 248 of cabinet 12 is used to form the hose storage area 222 there between. Hose storage area 222 has a cross-sectional area which is slightly greater than the cross-sectional area of the hose loop formed therein. Walls 246 and 248 are shown partially cut-away so as to illustrate a gravity feed self-retracting loop tensioner/retraction mechanism 250 formed in hose 220. Loop tensioner 250 is constrained for movement within hose storage area 222, and made somewhat self-retracting by comprising a rolling weight 252 having a groove 253 along its periphery in order to provide constant centering of the weight within hose storage area 222 and for providing a constant “loop forming” tension on hose 220. Furthermore, centering of the grooved rolling weight 252 within hose storage area 222 results in centering of hose 220, thereby preventing hose 220 from rubbing with the walls of hose storage area 222 during X, Y and Z repositioning of pickup head 224. In order to prevent binding of hose 220, rolling weight 252 is dimensioned so as to be slightly larger than the diameter of hose 220 and the width dimension of hose storage area 222 is dimensioned to be only slightly larger than the width dimension of rolling weight 252. The specific amount of weight used for rolling weight 252 is a matter of design choice, and depends upon various factors, such as the weight of the articles to be moved, the strength of the motors used to drive the hose in the Z direction, etc. In a further embodiment, it may be desirable to couple weight 252 to a lower portion of cabinet 12 using a spring, for adding further tension to loop tensioner 250.

It is also noted that this gravity-based retraction/hose storage technique meets the storage requirements needed for both the X and Y movements of carriage 218 (left/right and front/back), as well as for the Z movement of pickup head 224. Of course this gravity-based retraction/hose storage technique would work equivalently well in an embodiment wherein the robotic hose positioning mechanism used a rotary type device (R, Theta), an articulated arm, telescoping or scissor system, or other technique. Furthermore, the illustrated gravity-based retraction/hose storage technique is not necessary for the present invention, and in fact a fully or partially motorized retraction technique could also be used. Furthermore, in other embodiments, it may be desirable to place hose storage area at another location, such as parallel to the top or rear portion of cabinet 12.

Even furthermore, although only a single storage area 215, hose 220 and carriage 218 are shown in the illustrated embodiment, the invention described herein could also be used in a dispensing apparatus/article handler of the type having multiple storage areas and/or robotic article handling mechanisms, such as two robotic mechanisms (both positioned vertically or horizontally or mixed, and one vertically and one horizontally) each one serving a different storage area. Furthermore, when multiple article handling mechanisms are provided, each can be tailored for a particular operation. For example, one may have a relatively large diameter pickup head and use a high airflow/modest suction vacuum supply device, while the other may have a relatively small diameter pickup head and use a low airflow/high suction vacuum supply.

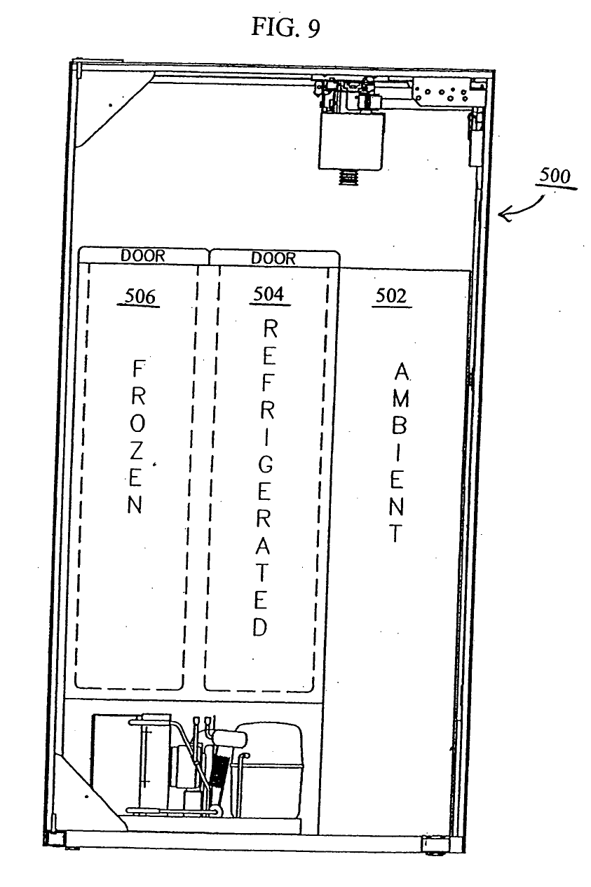

In this regard, FIG. 9 illustrates a multiple storage area arrangement 500, where a single article handler of the type previously noted serves 3 adjacent storage areas. In one embodiment each area may be for storing stacks of articles aligned in the same direction as in the other areas. One storage area 502 may have an ambient environment, while the other storage areas may be cooled, e.g., one area 504 being refrigerated and one area 506 being frozen. This arrangement may typically find use for dispensing in a compact, reliable and efficient vending structure: salty snacks (such as bags of potato chips) from the ambient storage area, cooled drinks (such as soda) from the refrigerated storage area, and frozen snacks (such as ice cream) from the frozen storage area. Furthermore, an arrangement of this type may be particularly advantageous in that the frozen compartment can be used for maintaining the quality of the stored articles until they are close to being needed for dispensing, as determined by an intelligent controller. At a predetermined appropriate time before dispensing, a certain amount of articles can be moved from the frozen area to the refrigerated area. This technique also finds particular advantage in the event that the third storage area is in fact a temporary storage area which is used for individually heating/cooking the articles, such as, e.g. frozen pizzas, using an oven or microwave. In this case the quality/shelf life of the frozen pizza is maintained by not moving them to the refrigerated area until the refrigerated area has been depleted to the point that it needs replenishment, at which time they are sequentially moved from the frozen area to the refrigerated area. This technique substantially reduces the time needed for heating the pizza while the customer is waiting, while at the same time allowing for storage of the pizza in a frozen manner, thereby substantially increasing its shelf life and reducing the labor costs involved in stocking the machine. In this arrangement, the refrigerated storage areas can include thermal separators at their top portions, such as an air curtain or sliding thermal panels.

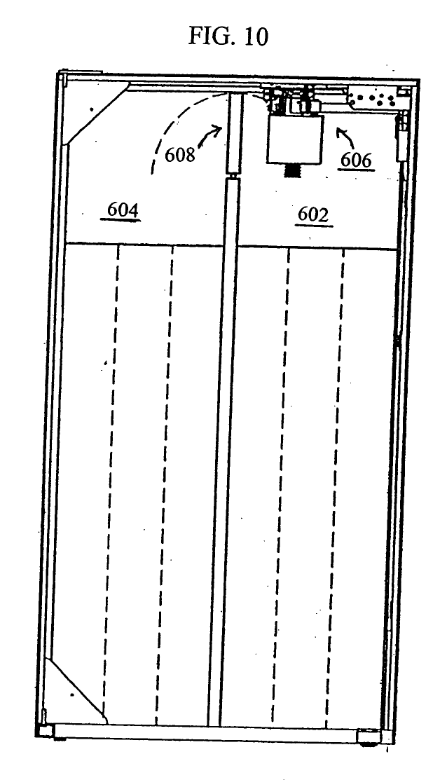

FIG. 10 illustrates an arrangement where the single article handling mechanism services two horizontally aligned in article storage areas, area 602 being an ambient environment and area 604 being a refrigerated environment. The article handling mechanism 606 can be constructed in a manner such as previously described using support beam 230 and carriage 218 so that mechanism 606 can “live” in the ambient area 602, and travel into the refrigerated area 604 through swinging door 608 as needed. Areas 602 and 604 can each include their own article ID device 254 or share a common ID device.

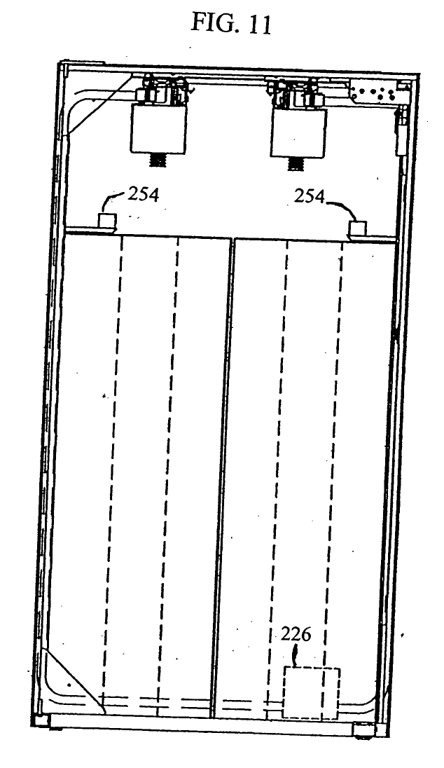

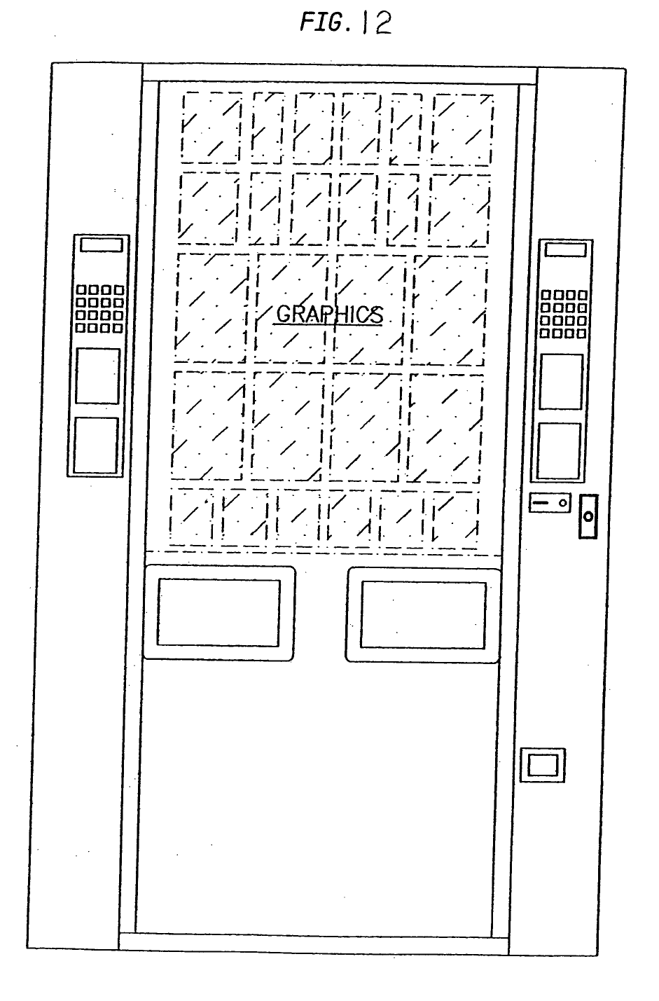

Additionally, separate hoses and hose positioning mechanisms can also be useful in order to speed up retrieval and delivery of stored articles to a customer. FIG. 11 shows such as a rapid article dispenser, of the type having two horizontally displaced storage areas. Although separate hoses and hose positioning mechanisms are used, they may share a single source of suction (e.g., blower motor 226), airflow sensor and vacuum breaker. A single hose, hose positioning mechanism and hose storage area could be used in a further embodiment where the single hose services more than one article storage area, such as the refrigerated and non refrigerated storage areas shown in FIG. 10. Each robotic article handling mechanism could have its own article ID device 254, or they could share a single article ID device 254.

FIG. 12 illustrates a vending machine having a single article handling mechanism with dual customer interface areas (each including a product selection apparatus such as a keypad or touch screen, payment system, and product retrieval door), for example, one on the left side and one on the right side, with a common graphics display therebetween. This machine can service two purchasers at substantially the same time since customer selections and payment typically take a substantial amount time compared to the actual time needed for the dispenser to deliver the selected product.

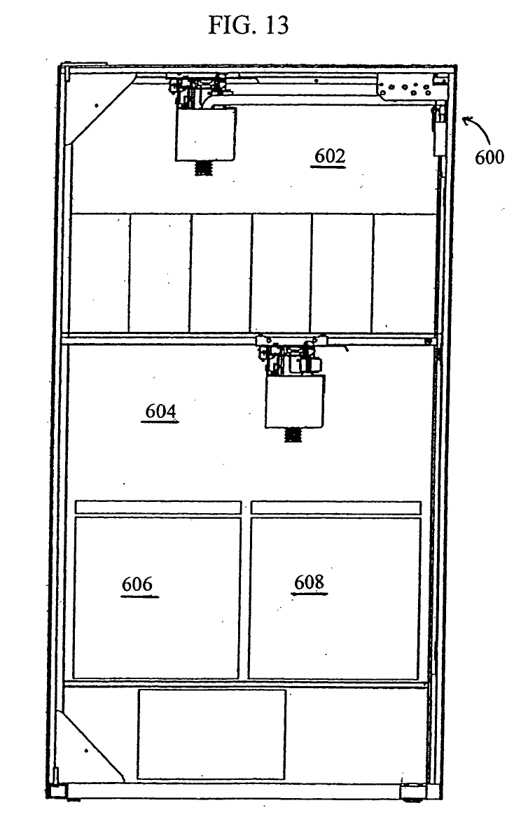

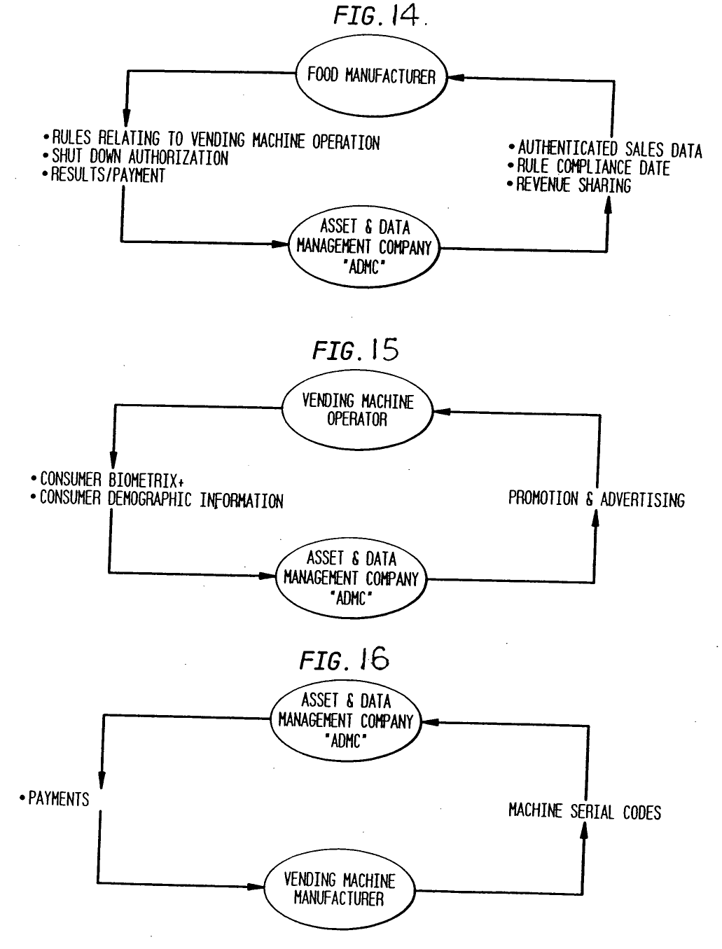

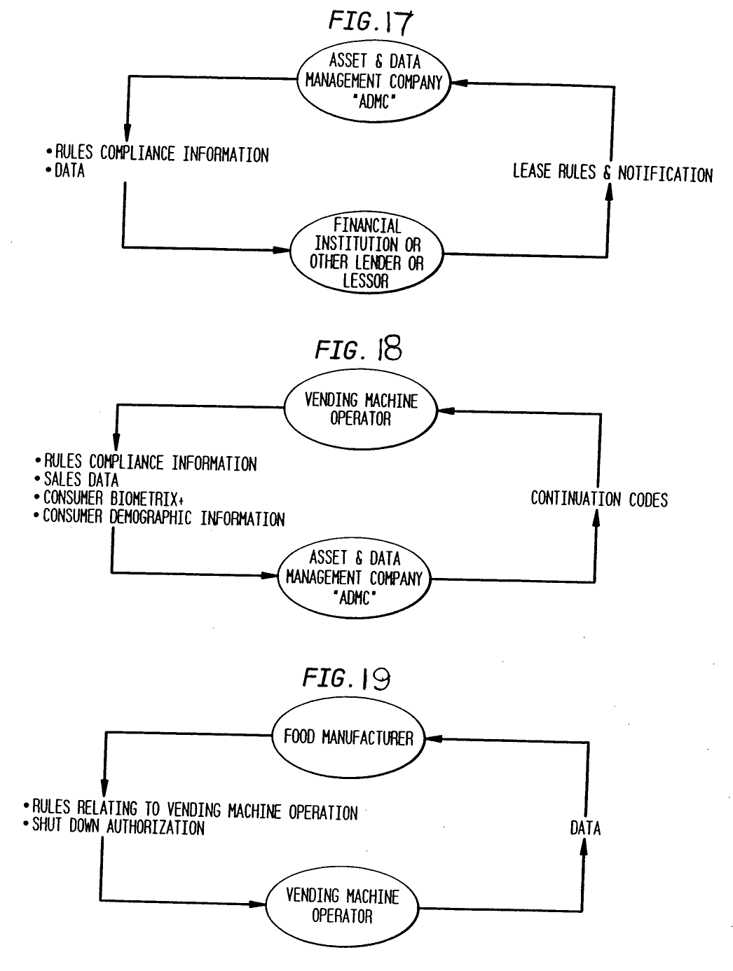

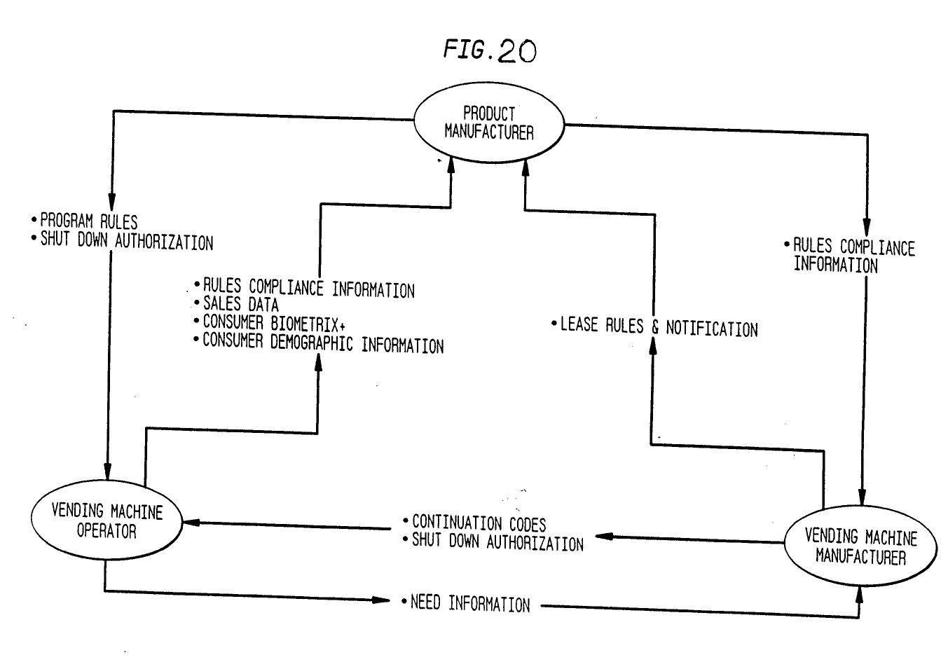

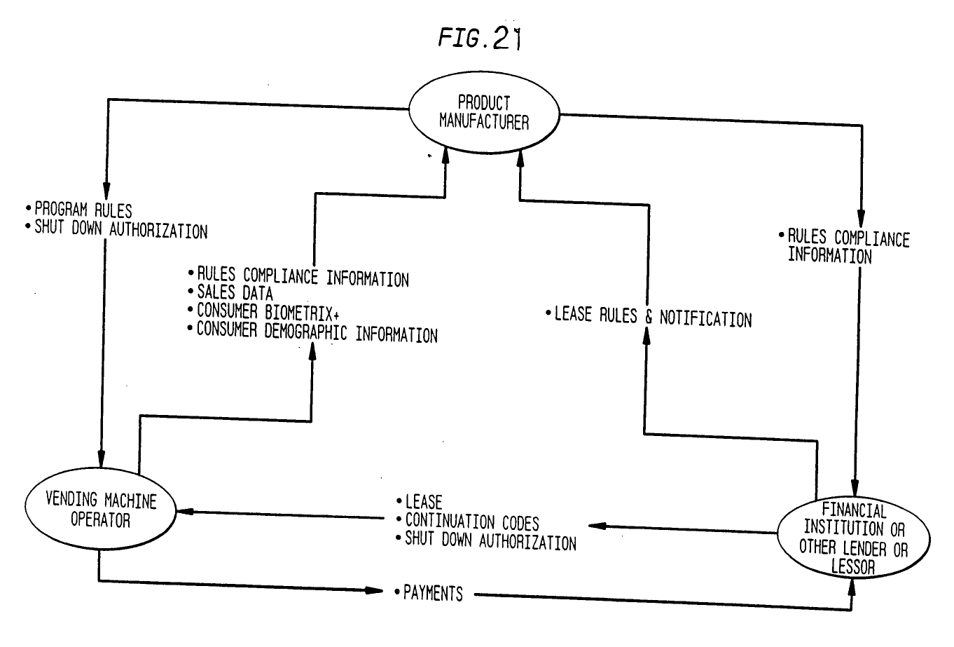

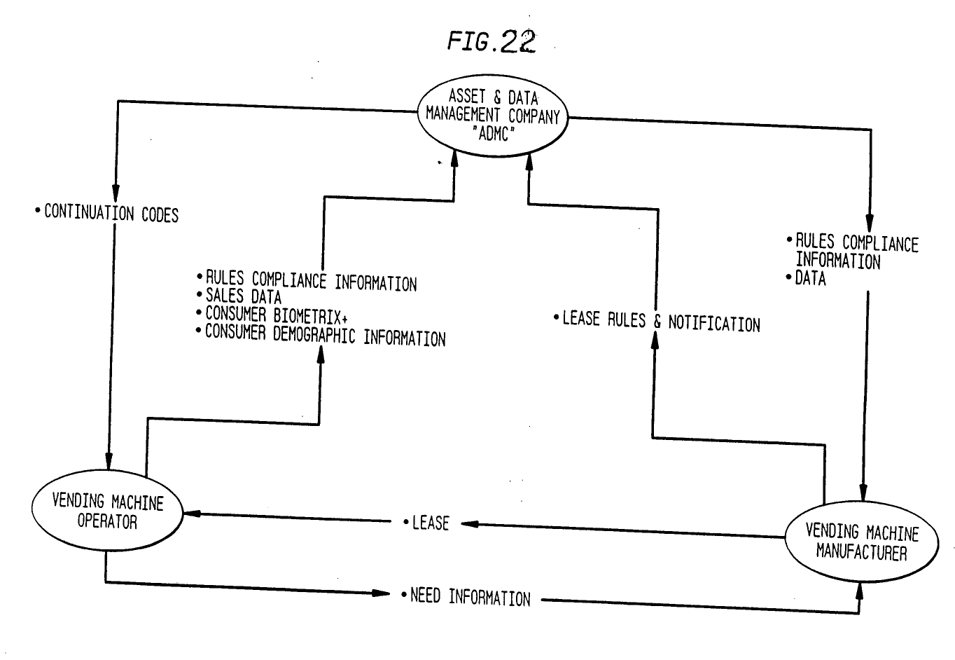

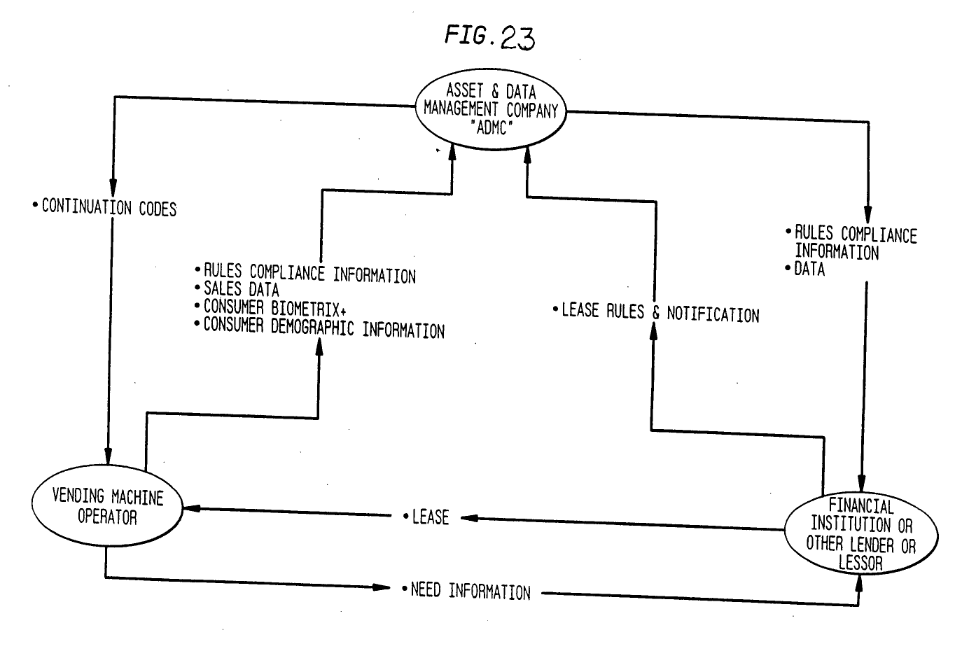

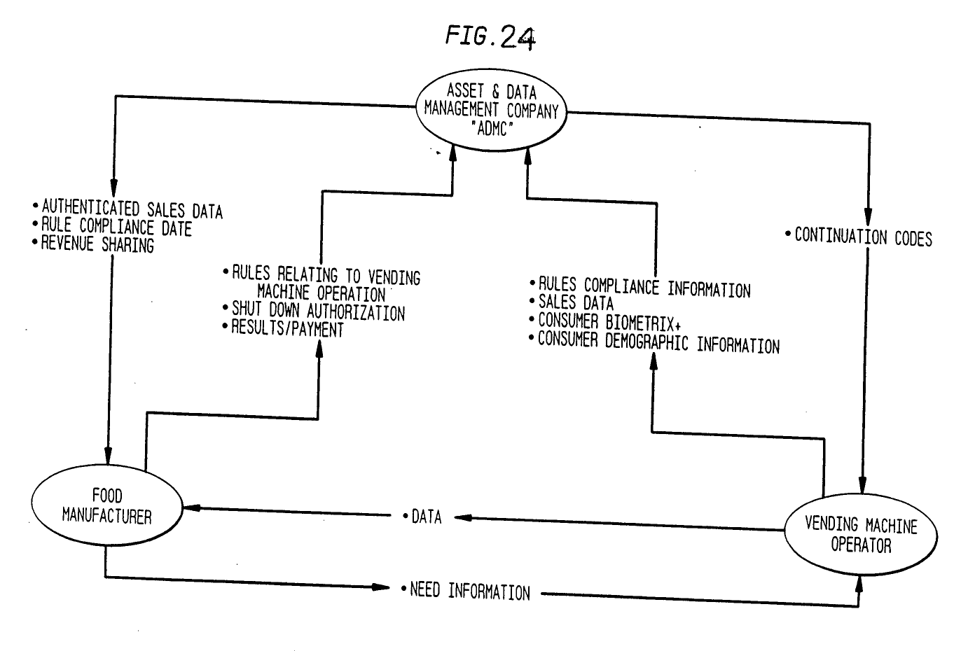

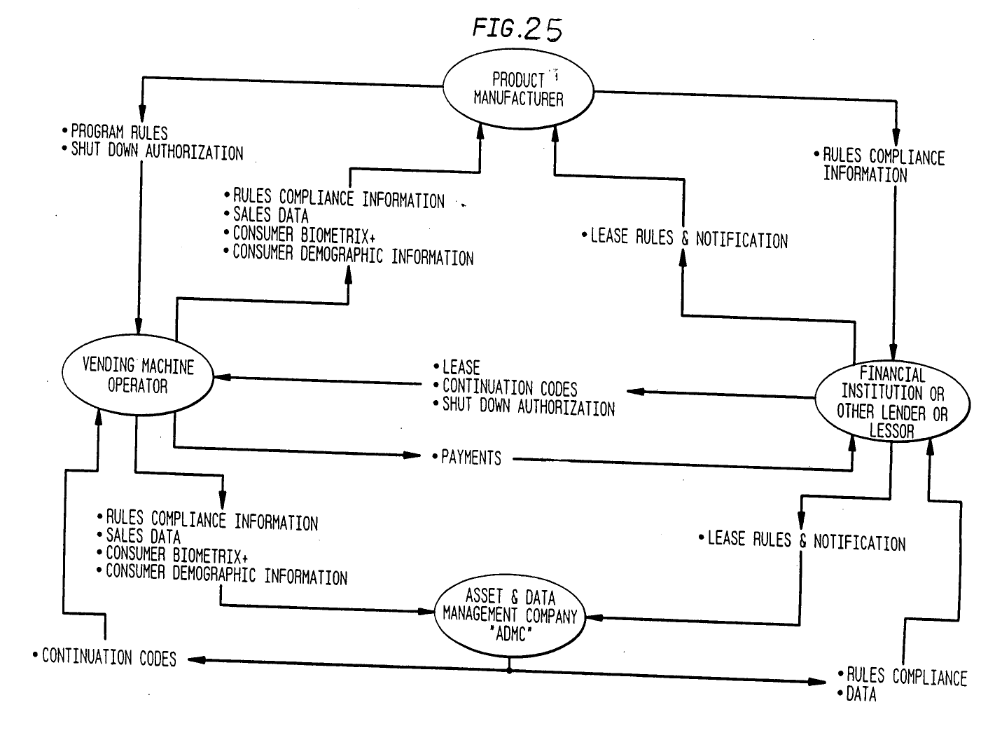

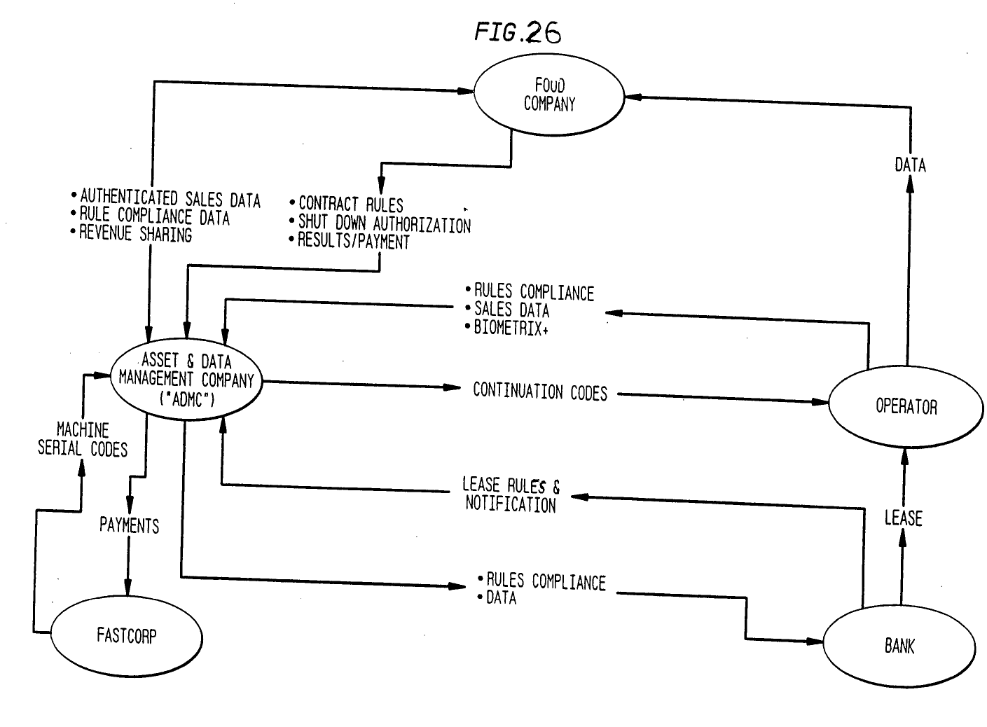

A further one of such arrangements is shown in FIG. 13, where cabinet 600 includes therein an upper area 602 which is non-refrigerated (and may even be heated) and a lower area 604 which is refrigerated (and may even be divided into, e.g., two additional sections, one area 606 being frozen and another area 608 being merely cooled). This arrangement is particularly advantageous since hot air tends to rise and cool air tends to sink. Alternatively, one storage area may be oriented for vertical storage of products and the other one, or even multiple ones, arranged for horizontal storage. In this case a separate hose, hose positioning mechanism and hose storage area may be required for the differently oriented storage areas.

In the above arrangements it is noted that the article handling mechanism can have other configurations such as the forenoted telescopic tubing, scissors, or R,theta arrangement. Additionally, the articles can be consumer goods, such as office supplies, printer cartridges etc.

In the embodiment illustrated herein, blower motor 226 provides a relatively high volume of airflow but a relatively modest negative air pressure. As a matter of design choice, blower motor 226 could comprise a vacuum pump, so as to provide a much more substantial degree of negative air pressure, but, due to size and cost limitations, a correspondingly reduced amount of airflow. In this latter case, the diameter of the air hose 220 would be reduced from the diameter illustrated in FIGS. 2 and 3, which may be particularly important in some applications of the present invention. The illustrated embodiment is particularly useful for picking up flexible packages since a momentary or even sustained leak in the coupling to the packaging to the article will generally not result in dropping of the package, while at the same time offering extreme versatility due to the ability to pick up a wide variety of shaped objects of varying weight and size. In the event that blower motor 226 comprises a vacuum pump, it could be used alone or in combination with a storage tank coupled to the suction hose via a valve and air hose, in order to provide a greater volume of airflow. Alternatively a compressor could be used in combination with a venturi device to create a vacuum.

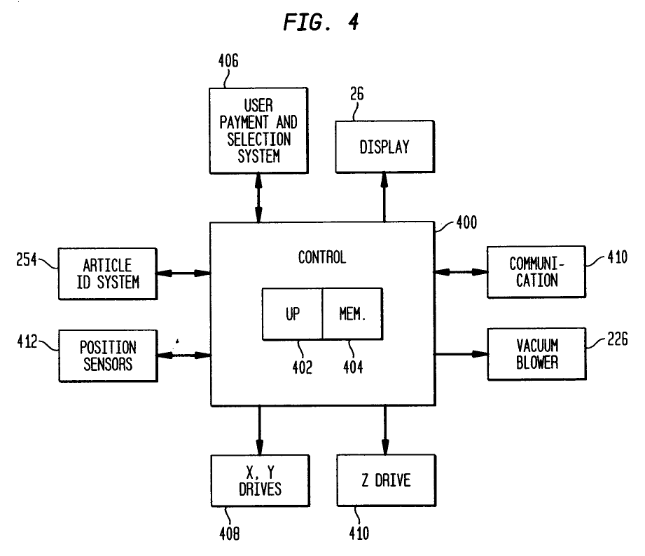

FIG. 4 illustrates a functional block diagram of the general operation of the various aspects of the invention described herein, as embodied in an article dispenser of the type comprising, for example, vending machine 10. A control system 400 including a microprocessor 402 and associated memory circuits 404, is constructed on control board 212. Control system 400 may also include the electronic parts of other portions of vending machine 10, as appropriate. Memory circuits 404 include ROM for storage of operating programs (embedded software, as well known, for accomplishing the described herein control of vending machine 10), as well as RAM cache for temporary storage of operational data during system operation as well as other data as may be needed. Control system 400 is responsive to user operation of the user payment and selection system 506 (including the coin and bill mechanism 28 and 30 and the selection buttons 40 of FIG. 1) for operating the user interface and article handling apparatus of vending machine 10 so as to dispense the article desired by a user. More specifically, upon proper payment for a selection made by the user using payment and selection system 506, control system 400 operates the X/Y (left/right and front/back) drive motors 508 so as to position pickup head 224 to be in alignment with a bin 216 which holds the article selected by the user. Control system 400 then engages a hose drive motor 410 (Z-motor) mounted within and carried by carriage 218, so that hose 220 is driven in a direction towards the top article in the aligned bin. At an appropriate time before head 224 contacts the article to be removed (and in an embodiment of the invention where cabinet 12 does not include refrigerated air, an appropriate time may be just before head 224 enters bin 216, but if the air is refrigerated, just before contact with the desired article is expected, in order to minimize removal of refrigerated air), control system 400 activates blower motor 226 so as to provide lifting suction at pickup head 224. Upon position sensors 412 determining that pickup head 224 has contacted and become secured to the desired article, control system 400 causes hose drive motor 410 to reverse its direction so as to retract hose 220 from the aligned bin 216 and thereby lift out from the bin 216 the selected article. Carriage 218 is then driven to a position in alignment with the article delivery chute 210. As the desired article 223 is moved along its way from a storage bin 216 to chute 210, it is positioned past the article ID device 254 for uniquely identifying and confirming that the article being dispensed is in fact the article that was selected. Upon sensors 412 sensing alignment of carriage 218 with chute 210 (in this case sensor 202 may comprise a reed switch mounted on a front wall of the cabinet, and a magnet mounted at a leading edge of carriage 218), control system 400 turns off blower motor 226 and the resulting loss of vacuum causes the selected article to drop into the customer retrieval area 22. As previously noted, in the event that the articles are so fragile that they should not be dropped or subjected to such impact forces, hose 220 can be driven to the bottom of chute 210 before the article is released.

It is noted that position sensor 412 may include the airflow sensor of junction box 229, or in a further embodiment, comprise a mechanically operated plunger-type position sensor associated with pickup head 224. Even furthermore, position sensors 412 may also include a reed switch mounted on a front wall of the cabinet, and a magnet mounted at a leading edge of carriage 218.

In accordance with a further aspect of the present invention, since the control system keeps track of the movement of hose 220 and carriage 218 (for example, by sensing pulses from a shaft encoder or other distance measuring device on each of their respective drive motors), the signal generated by the airflow sensor at the time carriage 218 reaches the virtual home can also be used as a check to ensure that control system 400 accurately counted the motor drive pulses, and can re-calibrate the positioning system based on the virtual home, if necessary.

It is noted that the above described carriage 218 and robotic hose positioning and drive mechanism, are particularly advantageous in the environment of a cabinet, such as in a vending machine, in that it facilitates improved utilization of the interior storage volume of the cabinet. More specifically, in the event that, for example non-storage related components are mounted or reside inside the cabinet, leaving “pockets” of storage area behind or in front of the components, the carriage is easily positionable so as to reach these pockets and make them usable for article storage.

A communication system 414 is connected to control system 400 so as to provide article inventory and vending machine operation information to a remote location, as well as to allow for control of the operation of the vending machine from a remote location. In this regard, communication system 414 may include a connection to means for making a wire-line and/or wireless transceiver interface through which a communication link with a remote computer can be established. Additionally, the communication system 414 may communicate with a plurality of other similarly connected vending machines in the same general area and communicate therewith using the wire-line interface or wireless communication. Even furthermore, communication system 414 can provide for communication with multiple vending machines and/or a local server/controller, in a local site along a LAN (local area network), LAWN (a local area wireless network) or a WAN (wide area network). The remote computer may comprise a database which receives and/or accumulates the operational data from one or more vending machines, which data is then accessible (via, e.g., the Internet, using a wired or wireless connection) using appropriate encryption, to others, such as route drivers, machine operators, machine owners, product suppliers, etc. Furthermore, the remote site may give feedback to the vending machines, such as authorization information, which can control its operation, such as allow its continued operation.

Further embodiments for the robotic hose positioning mechanism described above are contemplated to be within the scope of the present inventions. For example, instead of using a combination of left/right slides 234 and support beams 236a and 236b, a roller/guide rail combination as shown in FIG. 8 could be used. Support beams 236a and 236b may comprise a support plate 255 having two outwardly facing, i.e., opposed, L-shaped rails 256a and 256b along its longitudinal edges. In this embodiment, the function of slides 234 is accomplished by fixing a pair of brackets 258 to opposed ends of beam 230, each bracket 258 including a pair of spaced apart and inwardly facing rollers 260 which engage and follow the opposed rails 256 on the support plate 255. Furthermore, the spaced apart and inwardly facing rollers 260 could each comprise a set of rollers positioned to be angled 90 degrees with respect to each another, so as to engage or follow the two orthogonal surfaces of the L-shaped rails 256a and 256b. Such arrangement may result in a coupling of carriage 218 to beam 230 which needs less adjustment for proper operation. Furthermore, as previously noted, the event of substantially horizontal alignment of the storage bins, the robotic hose positioning mechanism can position carriage 218 for movement in a vertical plane which is substantially flat (i.e., in the X/Z or Y/Z plane) or in fact a vertical curvilinear plane. Additionally, as previously noted, in some aspects of the invention, it may be desirable for the robotic hose positioning mechanism to include a rotary device (R, Theta) of the type including an I beam of fixed length (or telescopic sections), for establishing the “R” movement of the gripper/pickup head, which pivots for establishing the “Theta” movement. Alternatively, in other environments for the invention the robotic hose positioning mechanism may include an articulated arm or scissor system, or other technique.

Accurate control of energization of blower motor 226 is particularly advantageous in the event that the inside of the cabinet, or a portion thereof, is refrigerated, since accurate control would decrease the amount of refrigerated air being displaced by blower motor 226. In the preferred embodiment, the microprocessor 402 will energize blower motor 226 as the pickup head 224 approaches the desired article, and in fact only when it is in the immediate proximity of the desired article (and not earlier), due to control system 400 maintaining updated information about the height of the stack of articles in each bin 216. The height is assumed to be at a predefined level upon article filling of the vending machine 10 by the operator. Control system 400 may confirm the assumed height by moving the pickup head 224 at a reduced speed towards an article at the top of a bin 216 on the first retrieval attempt after the storage area has been refilled, and then compare the assumed height to the actual height. Memory 404 can be pre-programmed with specific article heights in advance, or the heights can be learned by control system 400 by comparison of prior vend heights in each bin. Once the height of the top article is known, control system 400 is also able to always know the height of the next “top” article in that bin. Furthermore, control system 400 is also able to cause the pickup head 224 to approach the articles in that storage area at a higher speed, and only slow down when in the immediate proximity of the next “top” article in that bin. The technique to slow down upon the pickup head 224 approaching the next article also helps ensure that the stored articles will not be damaged by the pickup head 224.

When a “reset” switch (not shown) is activated by the machine operator, control system 400 automatically defaults to using the above height detection technique since it can be assumed that the operator may have changed the product load levels and consequently the product heights in each bin.

It is noted that in an alternate embodiment, a simpler way of controlling operation of blower motor 226 and the approach of pickup head 224, without knowing the specific article height, would be to turn on the blower motor 226, or slow down the pickup head 224 just prior to the learned stack height of the prior vend.

For the embodiments described herein, it is assumed that energization of the blower motor or other suction creating device (or alternatives thereto, such as a valve operated source of vacuum), is meant to be equivalent to the appearance of a prompt package securing force, i.e., suction, at the pickup head 224.

In accordance with a further aspect of the present invention, since the control system keeps track of the movement of hose 220 and carriage 218 by sensing pulses from a shaft encoder or other distance measuring device on each of their respective drive motors, the signal generated by the switch in airflow junction box 229 at the time carriage 218 reaches the dispensing chute 210 can also be used as a check to ensure that control system 400 accurately counted the motor drive pulses, and can re-calibrate its positioning system based on the virtual home, if necessary.

In the event that the stored articles could be easily damaged, and delicate handling is required, e.g., the stored articles comprise soft plastic bags of potato chips, further modifications to the above-described apparatus may be desirable. For example, in accordance with a further aspect of the present invention, the pickup tip 227 (shown in FIG. 2B) includes pleated or “bellows” type sides and is constructed of a soft compliant rubber or plastic, so that when tip 227 contacts a package to be removed, the sudden increase in negative air pressure inside hose 220 causes the length of tip 227 to suddenly decrease. This effect tends to rapidly and momentarily contract the gripping end of pickup head 224 from the article and might even apply a slight lifting to the package. This hose contracting/package lifting can be important, since weight portion 223 of pickup head 224 may be significant. Such weight may have a tendency to crush or otherwise damage a delicate package in the storage area if it makes a forceful contact with the package. The length of tip 227 and the aggressiveness of its “pleats” is a matter of design choice, and should be determined so as to provide a hose contraction by an amount which is equal to or greater than the expected downward travel of pickup head 224 due to time delay/lag in effecting a braking and stopping of the z drive motor (310 of FIG. 3), by control system 300 and its associated sensors, and the mechanical linkages associated therewith.

Alternatively, or in addition to the hose contraction provided by compliant tip 227, a sufficiently compliant hose 220 may be designed to provide a desired amount of lift.

In accordance with a further aspect of the invention, although speed is important, and generally the hose 220 is driven at a maximum allowable speed, when handling delicate articles, the speed at which pickup head 224 is driven by control system 400 towards a package to be retrieved, is reduced as pickup head 224 approaches the stored package. Since control system 400 maintains updated information about the height of each stack of stores articles in the storage bins 10, appropriate speed control, i.e., slow-down, during the approach of pickup head 224 towards a stored article can be accomplished. Such slow down provides some tolerance in the downward travel and reversal of pickup head 224, so as to prevent the weight associated therewith from “crashing” into and thereby crushing a delicate package. A similar type of speed control can also be used on the upward direction of pickup head 224, so as to prevent it from crashing into the underside of carriage 218, as well as at the ends of the left/right and front/back travel of carriage 218.

Additionally, wherein slide 228 has extended beyond the front edge of beam 230, the above-described mechanism for positioning carriage 218 is particularly advantageous in that it allows for a support beam, such as 22 which is limited in length so that it can travel within the full extent, i.e., wall-to-wall, within the cabinet of the vending machine (and behind corner support gussets, brackets and partitions such as partition 208 of FIG. 8, yet still allow for carriage 218 to extend beyond its front so that a desired article can be positioned into a customer retrieval area which is outside the interior confines of the vending machine cabinet.

Many of the benefits of the inventions described herein could also be particularly useful in an article dispensing apparatus of the type having a refrigerated compartment, such as a chest freezer including various doors thereon (such as described for the ice cream dispenser in U.S. Pat. No. 5,240,139), in combination with the forenoted controls for creating and/or maintaining suction at the gripping end of the suction hose.

While this invention has been particularly shown and described with references to preferred embodiments thereof, it will be understood by those skilled in the art that various changes in form and details may be made therein without departing from the spirit and scope of the invention as defined by the appended claims. In fact, many such changes are already noted in this description. Those skilled in the art will recognize, or be able to ascertain using no more than routine experimentation, many equivalents to the specific embodiments of the invention described specifically herein. For example, although a suction providing air hose 220 has been disclosed in the described preferred embodiments, in fact a solid element having a gripper at its free and, such as a mechanically operated claw (or an electromagnetic device or even a self-contained suction generator), could also be used. Such equivalents are intended to be encompassed in the scope of the appended claims.

### PART II

### FIELD OF THE INVENTION

The present invention is directed to a vending apparatus of the type described in Part I, and a method of operation therefore for dispensing articles, including some or all of the following:
a. An article ID device which can identify articles being dispensed from the machine (can include a camera, or a bar code scanner, and can apply to other types of dispensing machines such as spiral machines, food machines, beverage machines)
b. Ability to disable dispensing of at least some of the articles stored therein, in a predetermined fashion, without the need for any communication or any disable code being input from any source external to the machine or its control system (The control system is able to shut the machine down even if the whereabouts of the machine are unknown to an interested party)
c. Ability to re-enable dispensing of articles when an authorization code is received and input into the machine. (can be input by devices such as a keypad, a modem, a portable computer, a wireless device, a modem, a memory storage device, a telephone, an internet connection etc.)

The present invention is also directed to a dispensing machine with:
a. A control system which includes:
   i. A program memory for storing information relating to a limited number of article selections (for example No more than 20 selections)
   ii. A program memory which contains defined information detailing the identity of products which are authorized to be dispensed. (can also include ability to store the identity of products which are not authorized to be dispensed from the machine)

In one aspect of the invention, any or all of the relevant parameters in the control system can be adjusted, changed or eliminated by an authorized party. Many of these parameters are restrictions that can be used by one or more interested parties to enforce agreements and rules that the equipment will be governed by. These restrictions and changes thereto could include, for example:
1) determining the types of articles which are authorized to be dispensed or sold through the equipment
2) adjusting the parameters which determine when or how the equipment is partially or fully disabled.
3) Adjusting the programming in the control system to allow a machine to disable in six month intervals up from one month intervals.
4) Changing the control system to disable the machine based on the amount of product sold instead of based on the amount of time elapsed.
5) Eliminating any or all of the restrictions on the machine whatsoever
6) Changing the price that products could be sold for
7) Giving the ability to allow some or all articles to be dispensed for a reduced rate or for no charge
8) Changing the parts of the machine which will be disabled (eg. The coin mechanism, the dispensing apparatus, the bill acceptor etc.)
9) Changing the specific data that someone can gain access to.

### DETAILED DESCRIPTION OF THE PREFERRED EMBODIMENTS

The following description, consisting of Parts II & III, are to be read in conjunction with FIGS. 14 though 27, which illustrate various methods of operation for a vending machine and associated apparatus, such machine being described in Part I, as well as business relationships which can benefit from and utilize a vending machine and associated apparatus having the features of the present invention.

Potential Parties, Third Parties or Interested Parties

1) End Consumer

2) Location Landlord

3) Equipment Operator

4) Money Lender

5) Product Producer

6) Data Management Entity

7) Asset management entity

8) Equipment Producer

9) Interested parties are generally entities which have a vested interest in the equipment.
They can include but are not limited to;
   a. Companies that own the equipment
   b. Banks, money lenders, leasing companies,
   c. product manufacturers which may own part or all of a machine, or be giving subsides to the operator of the machine.
   d. vending machine manufacturers which may have a financial interest in the machine.
   e. Data management companies which expect to receive sales and other data from the machine. These entities may be independent and buy the data from the vending machine operator or other party that owns the data, or they may manage the data from the machines on for the benefit of another interested party, such as a consumer products company.
   f. Asset management companies which manage assets for the owners. For example, a food company may pay a management company to manage and protect the food company's machines.

Rule Enforcement,

Disables part or all of the system capabilities if:
a. Machine attempts to dispense unauthorized articles
b. The machine does not receive an authorization code prior to a specific time
c. The machine does not receive an authorization code prior to dispensing a specific amount of articles
d. The machine does not receive an authorization code prior to receiving a specific total amount of aggregate payments from end users

Revenue Sharing

The revenue sharing aspect of the invention relates to an interested party's desire to gain some benefit from the ongoing sales revenue generated out of a vending machine. In this aspect of the invention, there are many structures which can be beneficial to all parties involved. This method can involve as few as two parties but can also involve many more parties.

For example, a company that wishes to finance vending machines for a vending machine operating entity (the “operator” who makes money actually operating the equipment) can make the machine available to the operator in return for an agreed upon payment structure. This payment structure may or may not include a predetermined fee for the use of the machine. The payment structure can at least partially be based on the amount of revenue or related monies which are sold or dispensed from the machine. So in one case, the operator might pay the finance company a monthly fee for the machine as well as be responsible for paying a fee which is calculated as being a percentage of the sales or profits generated from the machine as agreed upon in advance.

In another aspect, the operator of the machine may have agreements with several parties relating to the same machine. For example, a machine operator may have five product manufacturing companies (companies A,B,C,D and E) one leasing company and one data and asset management company involved with the same machine.

All five of the product companies have an interest in their product being sold out of the machine. In this example, two of the product companies, companies A & B are giving free product to the vending machine operator in exchange for sales, location and demographic data on their products being sold by the operator, as well as an agreement from the operator to stock and sell at least 4 of any type of products, which are produced by companies A & B, in the machine. One of the product companies, company C, pays an up front contribution towards the cost of the machine in return for an agreement by the operator to always sell and stock at least 6 articles manufactured by the producer. Company C agrees to let the operator choose, at the operator's own discretion, any 2 of the articles produced by company C to put in the machine, however they both agree in advance that the remaining 4 product selections will be specific ones. Company D agrees to pay part of the monthly lease payment for the machine in exchange for the operator agreeing to stock and sell 10 specific article selection types at all times (produced by company D) and also in exchange for the operator agreeing to share a defined percentage (for example 3%) of his revenues with company D, to be paid by the operator on a monthly basis. Company E agrees to give the operator a one time payment and further agrees not to charge the operator for company E's products sold in the machine until one month after they are sold out of the machine (offering the product to the operator on “consignment”) in exchange for the operator agreeing to sell 8 specific types of company E's products out of the machine at all times and also pay 2% of revenue, from company E's retail sales through the machine, to company E.

There is also a leasing company which has leased the machine to the operator. Since the operator has a limited credit history, the leasing company agrees to lease the machine to the operator under the condition that the machine will be programmed by a third party (which can be the machine manufacturer or another authorized party) to disable itself in the event that an authorization code is not received and input into the machine on a monthly basis. This authorization code will be made available to the operator and the machine every month, on the condition that the operator maintains his financial obligations to the leasing company.

The product producers can each have similar agreements with the operator which would require them to authorize the release of authorization codes which need to be input into the machine in order to avoid the disabling a part or all of the machine. Separate authorization codes from the separate product companies (or from their agents)can be withheld in order to force a disabling of the product selections that relate to their individual agreements with the operator.

Since this can be a cumbersome situation for the product companies and even the leasing company to manage, they can authorize agents or utilize one agent to manage their interests in the machine. Such a data and asset management company can monitor the machine and require the sales and other data be reported to them from the machine operator (or the machine directly, if it so enabled) in order to confirm that the operator is following the agreed upon various contracts with the various interested parties which the management company is accountable to.

In this example, the Leasing company and the five product producers decide to utilize the services of the same asset and data management company. The management company also requires that a nominal fee(for example, 25% ) of the sales from the machine must be paid to the management company for their services by the operator. The management company now is legally bound and entrusted to manage the machine for the parties involved based on agreements (typically in writing). One other function that the management company can perform is to verify to the parties that there are no conflicts between the terms of any of the agreements involved, preferably this is done before any new contract is signed.

One function that the management company performs is getting any and all agreed upon data from the operator and or the machine so that proper decisions of authorization code releases can be made. This requires the machine to have the ability to compile the relevant data in a format that is transferable and meaningful to the third party( in this case the third party is the management company). In addition, it is important that the data which is retrieved from the machine is accurate and true and not tampered with. Advantageously, the machine should be equipped with the ability to encrypt or encode the data coming out of the machine so that an operator can not try to corrupt or adulterate it. Therefore, even though accessing the data and communication from the machine may depend on the operator's cooperation, the operator has no ability to change the authentic data from the machine. The external computer used to read the data and authenticate the operations of the machine will first be able to verify that the data has not been adulterated, since the encryption technique will verify, for example that the code sent has come from a specific machine at a specific time and in an authentic manner etc.

The above scenario puts the power in the hands of the product companies and banks. There is also the example where the operator “rents out” space in the machine in exchange for some of the machine's revenue, as described more fully hereinafter.

One, several or all of the interested parties could utilize a common agent, such as a management company, to protect their interests and to enforce their agreements, which agreement may be independent or combined, with the operator.

Agreements can have a term and the parties can agree what will happen to the restrictions on the machine or the machine itself at the end of a term.

A machine can be set up to facilitate both revenue sharing and rule enforcement. For example, where the asset and data management company acts enables the product producers in the example above, to collect their payments and apply them toward the leasing company until any excess is reached which is then forwarded to the operator.

Rules:

1) A vending apparatus which is controlled by control system, whereby upon the occurrence of a specific disabling event, said control system can cause the disablement of at least part of the functionality or capability of at least part of the vending apparatus, or to cause the disablement of an apparatus which operates in conjunction with said vending apparatus, unless an authorization code is received by the control system.
i. where the disabling is caused by a control system, which is linked to the machine, and which automatically occurs at a predetermined time or time interval.
ii. where the disabling event, as described above, is the passage of a specific amount of time (including a specific random amount of time.)
iii. where the disabling is caused by an electronic communication which is communicated to a control system, which is linked to the machine, which disabling communication can occur as determined by a third party or entity, other than the entity which has physical possession of the apparatus.
iv. where the disabling is caused by a control system linked to the machine when the machine has performed a specific amount of operating cycles.
v. Where the disabling is caused by a control system linked to the machine when the machine has dispensed a specific amount of articles.
vi. Where the disabling is caused by a control system linked to the machine when the machine has accepted a specific amount of payments.
vii. where the disabling is caused by a control system linked to the machine when the machine has performed a specific amount of operating cycles within a specific amount of time.
viii. where the disabling is caused by a control system linked to the machine when the machine has accepted a specific amount of payments within a specific amount of time.
ix. where the disabling is caused by a control system linked to the machine when the machine has sold a specific amount of articles within a specific amount of time.
x. where the disabling is caused by a control system linked to the machine when the machine has dispensed a specific amount of articles within a specific amount of time.
xi. where the control system contains at least one secure micro-chip, which has the ability to produce or store a code which can be utilized to verify the authenticity of a potential authorization code, which said potential authorization code has been communicated to the control board from a source remote to the vending apparatus.
xii. where the at least part of the vending apparatus as described above can include an apparatus or electronic device which is connected physically, electronically or communicatively with any part of the vending apparatus.
xiii. where the control system which controls the apparatus can be comprised of one or any of a combination and quantity of electronic controllers, computers or electronic devices.

2) A controlling third party (for example bank, product producer, data management company, leasing or finance company) controls the ability to release an authorization code to enable the partial or full functionality and capability of a specific machine.
i. In the event that the entity operating the machine is in violation of any rule as agreed upon by a controlling third party.
   1. Where the rules may include requiring the machine operating entity to;
      a. Communicate specified data to a third party.
      b. Make a payment to a third party
      c. Operate the equipment under specified guidelines
      d. Sell only articles or products which are authorized by a third party
      e. Maintain the equipment in an agreed upon fashion.
      f. Operate the equipment in a location which is specified.
      g. Maintain the product being sold in a fashion and with standards which are acceptable to a third party.
      h. Display graphics or pictures which are acceptable to a third party
      i. Sell product at a price point acceptable to a third party
      j. Not tamper or dismantle or disable any specific part of the equipment
      k. Not disable or tamper with a product ID device such as a bar code scanner
      l. Not move the machine from a given location
   2. Where the equipment has a multiple capabilities or functionalities, at least some of which, can be at least partially disabled in a manner as described above, by any one of a multiple, third controlling parties.
   3. Where the equipment has a multiple capabilities or functionalities, at least some of which, can be at least partially disabled in a manner as described above, by all of a multiple of third controlling parties.
      Article Producer Methods

Product/article producer has an interest in at least one article dispensing machine, and wishes to have ability to control aspects of the dispensing capability of the machine, further where the control(s) involves a set of rules that must be adhered to by the machine, further where the rules include at least one control parameter which determines the specific type of articles which can be dispensed, furthermore where the control system uses a ID device to determine whether a particular article is authorized to be dispensed, furthermore
1) where the article dispenser is being operated by a party other than the article producer and where the article producer is gaining the benefits of controlling its interests in the article dispenser by enabling the control system to follow a set of rules which are acceptable to and or determined (directly or indirectly) by the article producer.
2) Where the machine is set to partially or full disable some or all of the machine's functions in the event that the rules set in the control system (directly or indirectly by the article producer) are violated.
3) Where the dispensing machine can be reset by use of an authorization/enable code being received by the control system of the machine.
4) like (a) above where the article producer is able achieve at least some control over the machine (as stated above) by utilizing at least one other party (other than the product producer and or the vending operator/such as an agent, a broker, a data management company, a computer reporting company)
5) as above Where the authorization codes are able to be generated/stored in a data computer. Where the data computer is able to store data relevant to the rules and the history of rule adherence/violation by the operator of the machine.
6) Where the computer can do an automatic comparison between the rules and the historical adherence/violation data received from the computer associated with the dispensing machine (or portion/bin of the machine).
7) Where the data management computer can determine whether or not the continuation/authorization-enabling code should be made available to the control system associated with the dispensing machine.
8) Where the enabling code(s) are made available to the dispensing machine.
9) Where the enabling codes are not made available to the dispensing machine.
10) Where the data management computer system (network/computer/lan/wan etc.) is able to generate reporting information regarding the rule history of at least one of a given dispensing machine, which can be useful to the article producer.
11) Where reports generated can be utilized by article producer to determine whether to modify the rules for at least one machine operator.
12) Where data management computer can also have multiple article producers' separate rules being applied to at least one machine.
13) Where machine is set up to have a fixed number of total selections available as pre-set/controlled by a computer system (internal or remote).
14) Where the set number of selections is determined/limited by the control system and governed by the article producer +/or their agents rules.
15) Where the limitation of the number of selections can be modified only with the permission of at lest one the parties who set the rules.
16) Where the changes to the number of selections allowed is accomplished by an authorization code sent to a control system which controls the machine.
17) (need all of these claims also in combination with graphics and or tamper and or fixed graphics sheets etc. and or graphics with embedded security chips or RF tags (said rf tags/printing can be embedded in various non-detectable locations so that the machine will not function without communication to the graphics sheet.
18) Where continuation/enable codes for at least one of a given machine can be given to allow some of the articles in a machine to continue to be sold as normal and unrestricted, while yet other articles are not authorized to be sold.
19) Where codes can be sent to the machine in order to allow continuation of vending from at least one of a specific storage area of the entire storage area in the dispensing machine. (this is critical to allow MARS® to shut down bins from a violation on x number of bins, while still allowing HERSHEY® to operate bins which have not had a violation related to them (or even need to have claims which allow bins to be shut down without a specific violation of a rule, but for example, just because the contract is invalid or expired or under negotiation or non-existent)
20) Where the machine control system (need to define machine control system) will shut at least part of the machine's functionality down unless the machine control system has received authorization initiated from an external source (Ian, wan, Web, phone, wireless, handheld, micro device,) on a periodic basis.
21) Where there is a protocol between the machine control and the external control, whereby the machine control must first send data to the external control which data relates to the functions and certain specified (claim examples as dependents) sales related data, and or article dispensing data, (can include BCR data, machine usage data, uptime data, out of order data).
22) Where the outside control then does analyses of the incoming data received from the machine control system and makes determinations regarding what if any authorization codes should be released to the machine controller.
23) Where the authorization information/codes (and or disabling codes . . . in the case of a partial approval . . . where some bins may continue but others may not) are made available to the machine control system to enable the aspects of the machine which are authorized to be enabled.
24) Where the data sent back to the machine control include changes of rules for the machine which reflect changes to the contracts or rules agreed to by the involved parties (HERSHEY®—releases 2 bins for general all purpose use, MARS® “contracts” to get access to one of the ex-HERSHEY® bins, and the operator—in this case—use the other released bin to vend as he sees fit.)
   Business Method Scenarios

1. Whereby a Vending machine producer wishes to offer a machine to a potential customer on a trial basis for a limited time or for a limited amount of trial usage, and therefore sets the control system to have the ability to disable part or all of the vending machine and it's functions. This disabling can be determined and set to occur, for example, after a specific amount of time has lapsed, or after a number of articles have been dispensed, or after a specific amount of payments have been made to the machine.

2. Whereby a Bank, money lender, leasing company, financial institution, or investor or similar interested party has a concern regarding the fact that the equipment can be easily moved from one location to another. In order to improve their confidence that they can have some control over a portable asset such as a vending machine. The machine can be set to automatically disable unless an authorized code has been input into the control system. If the interested party such as a money lender has a concern about the whereabouts of the machine or the payments are overdue on a given machine, the money lender can decide not to release an authorization code for one or more machines. Since this would render the machines inoperable to the one in physical possession of the machine, the lender can be very confident that he will be able to either retrieve the payments due to him, or at the least the money lender, in this example, should be able to repossess the machine since it has little value to anyone in the disabled state.

3. Furthermore, the machine can have the ability to disable itself or be disabled in the event that the machine has been moved. This can be accomplished, for example, by putting sensors on the machine in order to detect the types of motion which would occur if the machine were to be moved. In the event, for example, that a machine has been lost or stolen and or sold to a third party in an illegal fashion and without the permission of the lender, the new person taking possession of the machine would naturally call the manufacturer of the machine, or their agent or distributor, in order to re-enable the machine. At that point, the inquiry could be used to alert the lender as to the whereabouts of the machine. In addition, the interested party can set the machine to display the phone number and other contact information or other messages on the graphic or digital display of the machine so that a person in possession of a stolen, lost or seized machine can know whom to contact. This message and the disabling feature itself also acts as an barrier to someone trying to sell a disable machine. Other interested parties, such as product and food producers, may also want to be able to control the movement of machines they have an interest in, and therefore they can also benefit from forcing the machine to be disabled in the event it is moved. Manufacturers who expect their products to be being dispensed at a specific location will want to know if a specific machine was removed from the location.

4. Any interested party may also have a desire to have access to certain information which can be communicated to them from the machine. Such information could include

Control Board And Chip Security

The data that the control system uses, in order to determine whether or not a given article is authorized to be dispensed, is able to be updated and uploaded from an electronic data input device such as a computer, a portable computer, a memory storage device or other similar input device. In addition, a keypad attached to the machine can also be used as the data input device. Can also be communicated by phone lines or a through a wireless transmission. The information and data being communicated to the controls system can be encrypted or secured using a known secure communications link.

In addition, high security computer chips which have specific security features can be operable in the control system in order to facilitate a secure transmission of data to and from the machine control system. These secure communications to and from the control system can safeguard against any unauthorized party from attempting to learn how to cheat the authorization code system. In this way, the control system cannot be studied by an unauthorized party attempting to ascertain what the next possible authorization code or code sequence is going to be.

In the event that someone were to try and replace the main control board with a “fake” board or a “cheater” control board, the machine can have one or multiple security devices or computer chips mounted in various components, apparatus and accessories throughout the equipment and machine. These security devices can communicate with each other so as to be designed to disable specific components or apparatus within the machine, in the event that any tampering of the control system has been detected by any one of the security devices in the machine. So, for example, if someone were to try and replace the main micro-controller board of the machine with an unauthorized controller board, security devices and features in components such as the motors, digital displays, touch screens, wire harnesses, keypads, encoders, switches, control boards, motor controllers, or any other electronic device, could be designed to disable one or several capabilities or functions of at least one aspect of an apparatus or part of the machine, thereby rendering the apparatus partially or fully disabled and inoperable. A security scheme such as described above can have many variations and embodiments, however the key idea of this aspect of the invention is to cause it to be highly impractical for someone to benefit financially by trying to cheat the system.

Additional, security measures can be taken in order to protect the electronics and control system of the machine from being cheated, such as embedding part or all of the control system in a potting compound or an epoxy thereby making it inaccessible. In addition, one could secure the control system by using more conventional methods such as welding or locking key parts of the control system in an enclosure. Such an enclosure could be removable for servicing, whereby the entire enclosure can be replaced by another authorized unit while preventing all the while any unauthorized person from gaining access to the key component. Additionally, certain operational code for the machine can be kept in high security chips so that it becomes more expensive for a person to try and reverse engineer the control system, forcing them to engineer a totally new control system.

Security measures such as those described above can give confidence to an interested party, such as a bank, a product manufacturer or a vending machine manufacturer, that they will be able to maintain some control over their investment and control over the machine. In the event that parts from a stolen machine are installed in another machine, they can be designed to not work without an authorization code.

While the preferred embodiment of the rule enforcement and disabling techniques described herein is described as utilizing a robotic vending machine, other machine designs can greatly benefit from the same business methods and the same disabling techniques and concepts. For example, some of these techniques can be modified to function successfully in spiral snack machines as well as beverage machines.

A machine programmed to disable itself after a certain predetermined amount of vending has occurred within a predefined amount of time, so that if the operator wishes to continue to use the machine for additional usage within that define time range they will have to pay for additional usage in order to re-enable the machine and continue to operate. If the operator negotiates this in advance he can avoid the shut down of the machine.

Where the disabling of the machine can include the disabling of any key apparatus or accessory associated with the machine, such as the bill validator, the coin mech etc.

Disabling Apparatus

For the optical article identification (ID) system:
A bar code or other image/vision recognition system for verifying stored article and/or proper operation and dispensing of article.
Use of a robotic mechanism for bringing stored articles to the article ID system the robot can pass the article in proximity to the ID device or scanner and move the product in a pattern to enable a code search process to help locate the code on the article.

Additionally, the controls system can use the information learned from a prior package code search to improve the efficiency of subsequent searches and search patterns of articles from the same bin, or presumed to be of the same type as one already scanned. For example, once the code of a certain article type has been found to be scanned with the robot a certain distance away from the scanner, then the next time a similar article is being scanned, the robot can begin it's search with the robot in the same relative position relative to the scanner as the point of success of the prior scan.

Even furthermore, the robotic mechanism can be selectively controlled so as to improve the reliability of article identification, i.e., movement of article past the ID system can be slowed, and for flexible bag articles, the article may be “jiggled” so as to change the flex of the bag and thereby improve scanning of a bar-code or better optical recognition of an image
Scanning for article ID can be at any time for verification and operation purposes, i.e., not just during or as part of a vend cycle, but also between cycles.
Proper operation and dispensing of article may include adherence to predetermined rules, and interaction with the control system for reporting and enforcement purposes, as well as further control of the vending machine for furthering the enforcement purposes. Articles identified as unauthorized can be put back in bin, or dispensed and then further article dispensing from that storage area can be disabled(unauthorized articles can also be automatically placed by robot in a special holding area for later inspection)
Article ID apparatus can also be manually used by the machine operator for inventory management.
Use of an optical ID system for spiral/Gravity feed machines to identify article package type, etc. prior to being dispensed, e.g., while article is falling (or rolling, in the case of beverage container etc.) or already landed at the customer retrieval area.
Determination of article ID is made during a dispensing operation, after dispense is initiated and the cycle is irreversible.
Article ID for inventory management, Pay As You Vend (PAYV) equipment financing, or for calculating incentives based on proper operation and/or adherence to rules * Addition of circuitry enabling remote connectivity of the vending machine for inventory management, as well as for operational control.

New business methods relating to the above-noted enforcement possibilities. That is:
Once there is article ID (such as a bar code scanner,—and/or a camera) along with other data available about the dispensing operation of the machine, it is possible to set up rules for the “Authorized” operation of the machine, and if those rules are not followed, part or all of the vending machine can be shut-down.
The enforcement possibility facilitates among other things “Pay As You Vend” (PAYV) business methods, where the purchase price (or a lease or bonus payment) of a vending machine, or for that matter any other type of article handling/dispensing apparatus, can be set up so that, as an example, periodic payments are made based on the quantity or value of the articles handled during a given time period. If the data needed to calculate the payments due by the party leasing the equipment, or the payments themselves, are not provided, the machine may be pre-programmed to automatically default to a shut-down mode at some point in time. If the payments and/or data are provided, authorization codes are given to the operator (preferably before the equipment has been shut down) which prevent the default shut-down. An authorization code can also be given to re-activate a machine that has been fully or partially disabled in a vending machine environment. This can be implemented by a machine manufacturer (or a distributor[ or a], finance company, or a product manufacturer), providing a vending machine to an operator, and require that the operator make periodic financing payments based on the quantity or value of the articles vended during a given time period prior to the payment date.

Furthermore, the machine can be pre-programmed to shut-down if an authorization code is not entered at periodic intervals. The authorization code could be given to the operator, or communicated to the machine if the proper payment, and sales data are made. This results in a win-win situation for both parties, since the more successful the operation of the machine, the more money is available for the operator to make larger payments, and the more money the manufacturer or lessor is able to make in a given time period.

New business methods relating to advantages provided to the machine operator by the above described novel apparatus. For example:
Once a reliable and verifiable database of sales data is available, it can be used to obtain volume discounts, both for the operator (from the article manufacturers), and for loyal customers (from grateful operators or as a promotion, etc from an article manufacturer).
Once a reliable and verifiable database of sales data is available, it can be used as a feedback tool to the machine operator, where adherence to predetermined rules may result in the operator getting an incentive or bonus.
Once a reliable and verifiable database of sales data is available, it can be used as a basis for a lease payment for the space where the machine is positioned, such as at a shopping mall.
The database can be made accessible to interested parties via the Internet or other remote accessing technique, which will further facilitate this business method.

Use of article/article handling/dispensing of the type noted above, in alternative environments:
Gas stations islands, where products are delivered to the customers using, e.g., a pneumatic tube, from a remote storage area using an article/article handling/dispensing apparatus for dispensing the products prior to being placed into the tube
Automated convenience stores
Automated supermarkets, etc.
Automated storerooms/stockrooms in an office building, etc.

The apparatus and a business method as described herein, wherein the article identification is used by the user interface and control apparatus for making all or part of the apparatus inoperable.

A business method as described herein wherein inoperability of the apparatus is used as an enforcement mechanism to stimulate adherence by an operator or owner of the apparatus to predetermined rules.

A business method as described wherein inoperability of the apparatus is used as an enforcement mechanism to stimulate reporting of sales and inventory data to a central authority.

A business method as described herein, wherein inoperability of the apparatus is used as an enforcement mechanism to stimulate adherence to plan-o-grams (proper article layout by person stocking the apparatus with article, i.e., the route driver).

A business method as described herein, wherein an incentive or bonus is provided to the route driver for adherence to the plan-o-grams.

Relating to Article ID System for Spirals

An article dispensing apparatus, comprising:
a storage volume for storing articles along a plurality of longitudinal axes;
a plurality of article transporting mechanisms, each including an elongated spiral-shaped article transporting device for selectively transporting an article along one of the plurality of longitudinal axes and out of the storage volume;
a drive mechanism coupled to each article transporting device for rotating a selected one thereof for causing transportation of an article out of the storage volume; and
user interface and control apparatus for allowing a user of the dispensing apparatus to initiate an article dispensing operation, and to cause controlled rotation of the article transporting device so that a selected article is extracted from the article storage area and moved along a path to a dispensing area of the dispensing apparatus, and
an article identification device, mounted within the dispensing apparatus, and operated so as to provide identification of an article before, during or after it moves to the dispensing area

The apparatus described, wherein the article identification device uses imaging optics to provide article identification.

The apparatus described wherein the article identification device comprises a bar code scanner.

An Apparatus wherein the article identification provided by the article identification device is used by the user interface and control apparatus for:

a) shutting down or disabling further dispensing of articles in alignment with one or more of the longitudinal axes.

An Apparatus, wherein disabling of said dispensing is overcome, or re-enabled, in response to input to the control portion of the user interface and control apparatus of an encoded authorizing signal.

An Apparatus wherein disabling of said dispensing is overcome, or re-enabled, in response to the passage of time.

As Directed To Restriction Capabilities

An article storage and retrieval and/or dispensing system/apparatus which includes a the following:
At least one article retrieval mechanism;
At least one article identification system including at least one article identification device and/or input device(such as a bar code scanner or camera and vision or optical identification system);
c) A plurality of article storage areas wherein articles authorized to be retrieved and/or dispensed are stored; and
d) At least one control system for controlling said article retrieval mechanism, said control system being preprogrammed to disable the ability of articles to be retrieved and/or dispensed based on a given operational parameter reaching a threshold value;
e) further including,
   means for providing an externally input authorization signal for overcoming said preprogrammed disabling, and/or
   means coupled with the article ID system for detecting attempted retrieval and/or dispensing of unauthorized articles, and deactivating ability to retrieve articles from at least one of said storage areas, and/or
   communication means for providing communication between said control system and a remote site, wherein if said communication means is disabled or tampered with, ability to retrieve articles from at least one of said storage areas is deactivated, where communication means can be a digital display, a portable computer, a memory storage device, a phone line, wireless, internet etc.
   whereby said article ID system performs self-checks, and if evidence of tampering with proper operation of the ID system is detected, the ability to retrieve articles from at least one of said storage areas is deactivated, and/or
   wherein once ability to retrieve articles from at least one of said storage areas is deactivated, a new authorization code is required to reactivate the apparatus.
      Specific Storage Area/Article Restrictions

Article retrieval system ( which may or may not include a specific single customer interface, as in the case of an automated store) which contains a memory capable of storing information such as the information relating to the articles which may be stored in the article storage area(s).
1) whereby the control system is capable of determining whether or not an article which is identified by the ID system is an article which is authorized to be stored/retrieved/dispensed in/by the apparatus;
whereby (in one example) there are less ID systems/input devices (Scanners) than there are storage compartments or spirals etc., and/or
whereby there is only one ID input device, and/or
whereby the article is moved from initial storage area (to a central scanning area) in order to scan article, and/or
whereby a memory/database of articles (data stored in controller memory or external computer memory) is provided, including the list of articles which are authorized to be dispensed from said dispensing device
2) Whereby the control system is able to deny/deactivate the access of future retrieval attempts by the apparatus of any specific articles/storage area(s), in the event that the article ID system or the control system has determined, that a specific article which was previously retrieved from that same area was not an “authorized article”. This is based on a comparison between the article ID information gathered by the ID system on a given article and a list of authorized articles which is stored in the memory accessible to the control system (e.g., from a web-site , off location/external database, an internal memory, etc.).
Whereby the determination of the authorization of a specific article is made after the article is removed from the storage area, and/or
Whereby, after the control system has detected an unauthorized article, the control system prevents any further retrieval of articles from that specific area, and/or
This restriction can not be cleared by the operator unless physically present at the machine, and/or
Whereby the first detected unauthorized article from any specific storage area is dispensed into the retrieval area, and/or
Whereby the first detected unauthorized article from any specific storage area is placed back in the original storage area/container, prior to deactivating further access to that same storage area/container in the future, or
Whereby the first detected unauthorized article from any specific storage area is placed into a separate article rejection storage area/container, prior to deactivating further access to that same storage area/container in the future, or
Whereby the control and or article ID system above has anti-tamper features including mechanical, electronic, software, electronic hardware systems which disable use of the control system and thereby disable the use of the whole retrieval/dispensing apparatus in a temporary or permanent fashion in the event that tampering of the system has occured
   a) whereby the above tamper resistance mechanisms include the requirement of access to an encrypted code, which must be input into the control system ( via numerous possible methods, wireless, manual keypad, modem, handheld computer, etc.) in order to re-activate the apparatus after a tamper related deactivation of the apparatus has occurred.
   b) whereby the control system has at least one tamper evidencing system which enables an authorized person to detect the unauthorized tampering with the control/ID system.
      Revenue Sharing Concepts; Pay-As-You-Vend (PAYV)

An apparatus for providing a product¹ to a user of the apparatus, comprising:
¹ defined in the text as goods, services or information

a first validating device (i.e., the selection buttons and the payment mechanism), responsive to operation² by the user, for internally generating a first validating signal representative of a user desired product from the apparatus;
² e.g., selection and payment

a second validating device, responsive to an input to said apparatus from a remote site in response at least in part to payments, of an encoded signal, for developing a second validating signal; and

a controller, requiring prior receipt of both of said fist and second validated signals, before allowing said apparatus to provide the selected product to the user.

The apparatus wherein said controller includes an accumulation device for developing a disable signal which prevents said controller from providing the selected product to the user, based on an accumulated value of at least one operation parameter³ of the device reaching a predetermined value.
³ such as one or more of “time, cycles, $ sales”

The apparatus wherein the operation parameter comprises one of:
time,
$ sales volume
# of sales transactions.

A method of operating an apparatus for providing a product to a user of the apparatus upon product selection and payment by the user, comprising the following steps:

providing an apparatus where a non-user operator of the apparatus must make payments to a third party, based on an accumulated value of an operational parameter of the apparatus.

A device for providing a product¹ to a user of the device, comprising:
a selection mechanism, responsive to operation by the user, for generating a user selection signal representative of the user selecting a desired product from the device;
a processor, responsive to accumulation of at least one operational parameter of said device, for generating reporting data representative of accumulated user operation of the device;
(optional) an output, responsive to said processor, for providing said reporting data externally to said device according to a predetermined schedule;
an input, for receiving an encoded authorizing signal which is generated at least in part in response to the providing of said reporting data to said output;
(or—an input, for sequentially receiving encoded authorizing signals, each encoded signal being generated at least in part in response to a scheduled providing of said reporting data to said output)
a decoder, for decoding the encoded authorizing signals so as to develop a decoded authorizing signal;
a disabler, responsive to at least one operational parameter of said device, for developing a disabling signal after said operational parameter reaches a predetermined accumulated value; and)
a controller, which once disabled by application of said disable signal, is enabled by application of said enabling signal thereto, and can then respond to one or more of said user selection signals and provide product to the user.
   ¹ defined in the text as goods, services or information

A device for providing a product¹ to a first-type of user of the device, comprising:
a selection and payment mechanism, responsive to operation and payment by the first-type of user, for generating a user selection signal representative of the first-type of user selecting and making an appropriate payment for a desired product from the device;
an accounting means for keeping track of an accumulated value of at least one operation parameter³ of the device;
a memory having stored therein a predetermined accumulated value for the at least one operation parameter of the device, said accumulated value based on a payment by a second-type of user of the device to a third party; and
a comparator, coupled to said accounting means and said memory, for comparing the accumulated value of the operation parameter to the stored value, and applying a disabling signal so that said selection and payment mechanism becomes inoperable if said accumulated value is greater than said stored value.
   ¹ defined in the text as goods, services or information
   ³ such as one or more of “time, cycles, $ sales”

The device described above further including
a controller, for controlling the operation of the device, the controller having a first input responsive to said disabling signal for preventing said device from providing a selected product to said user even if the user has made an appropriate selection and payment, and the controller having a second input responsive to an authorizing signal for preventing said disabling signal from being at least partially effective.

The device wherein the authorizing signal is automatically generated internal to said device based on the passage of time.

The device further including a resetting mechanism, responsive to an internally or externally input authorizing signal for resetting the accumulated value of the operation parameter in the accounting means to a starting (i.e., minimum) value.

The device (define the difference between the first and second-types of users, i.e., first-type is actual purchaser of product from device, and second-type is one who operates the device as a business for selling to purchasers).

The device wherein said controller creates notification/communication to the second-types of users (owner/operator) of the status of the comparator.

The device wherein said controller is coupled to a communication path (internet, wired or wireless modem), to send communication to a remote site for accounting and generation of the authorizing signal.

The device wherein the authorizing signal may only authorize a partial operation of the device.

A method for providing a product¹ to a user of the device, comprising the steps of:

controlling operation of the device so as to selectively provide said product to a user;

preprogramming the device to automatically shut down (i.e., prevent selectively providing of said product to the user) based on accumulation to a predetermined value of a give operation parameter of the device, or accumulating at least the one operation parameter³ of the device during operation of the device.
¹ defined in the text as goods, services or information

³ such as one or more of “time, cycles, $ sales”

The bar code reader mounted to an interior wall of cabinet and positioned so that the article moves over the scanned surface thereof during the dispensing operation. In this manner, control system can maintain accurate information relating to the articles dispensed by the vending machine, thereby enabling new methods for operating a vending machine, a business for operating a vending machine, as well as a business for financing or leasing a vending machine, as described in other parts of this application. Since article ID is accomplished during dispensing, while the machine is not normally attended by the owner/operator, as compared to during loading, more reliable operational information is developed by the sales management information system. Although a bar code scanner is illustrated, alternative imaging systems could be used. For example, a digital still camera, an analog or digital video camera (or similar imaging device), or a radio-frequency (RF) ID device, may be used for obtaining article ID information.

PAYV

The above described apparatus can facilitate new business methods relating to article or article identification during or as part of a dispensing apparatus.

Traditionally, feedback of article ID is important as an analysis tool for the equipment owner (or operator or food manufacturer) for inventory and/or plan-o-gram information (product positioning or lay-out in the apparatus).

1. Equipment Control System

A. Feedback tools using a microprocessor
1) barcode or radio-frequency (RF) scanning for article identification
2) optical (imaging) article identification system, for example, a digital still camera, or an analog or digital video camera or similar imaging device for obtaining article ID information.
3) Meter: for monitoring time, as well as total or incremental sales volume or receipts over time, and using the monitored information to control continued operation of the machine.
4) Meter: for per bin monitoring and control as noted in 3) above.
5) power outage/tamper sensors/machine transport sensors
6) maintenance (trouble) sensors

B. Feedback communication link for transmitting encrypted code
1) wireless: cell, beeper, infrared, radio frequency (RF)
2) verbal/telephone
3) modem
4) hand-held device

III. Control Data Processing Center

A. Managed by or for the owner/operator
1) in order to give feedback for machine sales, SKU's, time, volume, employee performance, etc.
B. Managed by or for financial backers (interested parties)
   1. for purpose to determine sales, total or incremental
2. to authorize continued use of machine using authorization (enforcement) codes
   a) flat rate installment financing
   b) PAYV (Pay As You Vend) where the financial party gives authorization codes for continued operation of the machine based on successful periodic payments for incremental use of the machine above a minimum use agreed upon in the financing arrangement
   c) monitor cash receipts to determine machine thefts or illegal sales as a result of using an unauthorized control system which bypasses regular monitoring and reporting.
C. Managed by or for the article manufacturer (such as M&Ms, Pepsi, or a management agent for an article manufacturer)
1. for purposes of monitoring and controlling compliance by the equipment operator to predetermined and agreed upon rules, and when meeting the rules giving authorization codes to the equipment operator (for continued operation of equipment.)
a) such as x percent of article bins for vending the article of a particular manufacturer
b) x percent for no bins of a competitor's article
c) maintaining payments for article being timely made and current including rental lease payments, etc.
d) any other agreed upon terms (i.e., reporting in a timely manner)
e) meeting terms gives access to the proper encrypted data
f) allowing food company access to machine location and sales data

IV. Possible On-Board Machine Enforcement Features
A. Machine defaults to shut-down when:
   1. predetermined time intervals, e.g., every three months
   2. based on tampering of the machine via physical movement, or removal of computer board for control system, or removal of article ID or tampering with article ID system
   3. full or partial shut-down of machine based on non-inherence to authorized article sales
   4. based on a given dollar amount of sales within a given time interval
   5. to reconcile the account once per year based upon time, for example, x sales, like a debit card with no time limit or
   6. x sales per unit time (e.g., $2000/3 mos.)
      a) the above two billing schemes require periodic payments, monthly or yearly, and if not paid by a certain time or if paid late, the machine is preprogrammed to shut down, or it can be manually shut-down using wireless control, etc.
B. Machine requires authorization code from a governing body (e.g., the central data processing center)
   1. prior to restarting the machine after a shut-down
   2. prior to shutting down, based on an agreed upon time interval shut-down
   3. obtain authorization codes from a governing body in order to allow machine to continue its operation
      a) prior to a total dollar sale amount meter running low, or
      b) prior to a timed shut-down, or
      c) restarting after a prior shut-down
C. Controlled partial shut-down of the storage area
   1. in response to detection of unauthorized article in system

V. Alternatives to consider
A. Default is to shut down machine
   1. machine internally senses improper sales, or adherence to rules and shuts itself down
      Restricted Vending Machine

1. Revenue sharing: where payments by the operator or renter/lessee to the owner/lessor of the equipment are based on usage of the machine or, usage can be based on operation cycles, an accounting of time that the operator has had use of the equipment, the amount of money that the apparatus has generated, etc.

Typically, revenue sharing between an owner and an operator of the apparatus is based on DATA descriptive of the usage/operation of the machine. Prior art attempts at revenue sharing have been less than satisfactory because usage data can be falsely reported , or not reported at all. Furthermore most revenue sharing arrangements between an owner and an operator require the operator to make payments to the owner, which payments can be difficult to collect, especially since the owner may not even know exactly where the equipment is located.

For these and other reasons, the present invention provides an equipment (such as a vending machine) which has a built in enforcement system. This enforcement system partially or fully disables the apparatus in the event that the machine is not operated in accordance with preset rules which the operator and the owner of the machine agreed upon in advance. Revenue sharing arrangements can include linking the operator's cost of using an apparatus to the revenue which the apparatus will generate. Therefore it is possible to make equipment available to an operator in a way that reduces the operator's risk. This risk to the operator is reduced since the typically fixed costs associated with renting or buying the equipment are now variable. This enables the operator to have much more flexibility and encourages business expansion into business opportunities that would have previously been riskier or not viable at all. This has benefits for both the equipment operator (e.g. reduced risk and greater financial flexibility) and the equipment owner (e.g. increased sales of equipment, and can offer same equipment at variable costs to customers based on usage without jeopardizing the high profits which are generated by conventional sales on equipment which may have no restrictions).

Obviously, the revenue sharing business method can include sharing revenues or revenue based payments with parties other than the operator and/or the owner, such as payments to a product producer who is subsidizing the equipment or a real estate owner who provides space for the equipment (e.g. such as at a shopping mall or a factory).

2. Adherence to rules agreed upon by an equipment operator and owner (or other party with a vested interest) of the machine. In the case that, as an example, a product producer who may sell the products or services to be vended from the apparatus (or another interested party) wishes to subsidize (partially or fully) the cost of a piece of equipment, there are often rules that the parties agree to in advance. These rules may typically require the operator to sell only certain types or kinds of merchandise through the equipment. Various arrangements are generally known where usage of a part or all of a piece of equipment will be restricted to a certain type of product or a specific brand. However, again these relationships have been based on trust and whatever reporting methods can be employed. In some cases, electronic reporting from the equipment directly or indirectly through a communication device can be used to inform the necessary parties as to the true nature of the usage of the machine. Several problems still exist however.

One problem is that the owner has little or no direct way of enforcing his agreement with the operator. Currently, the Owner or interested party (perhaps in this case, a product producer) may have a difficult time verifying the reports from the equipment operator. Furthermore, the operator may not always be willing to be cooperative with the owner or other party and may not give them access to the necessary data from the apparatus. Even still further, even if an operator is willing to share data with another party, the operator may also find it hard to authenticate the specific products vended from an apparatus. For example, in a traditional spiral type vending machine, the selection D2 may be thought of as storing one specific type or brand of product, when in reality the spiral instead is storing and dispensing a totally different brand or type of product. Regardless of whether the equipment is intentionally or unintentionally loaded incorrectly, the route person in the field might be the only one who realizes the discrepancy (if anyone realizes it at all). Therefore it is desirable to have the ability to Verify the identity of the actual product being stored in the apparatus.

Other attempts have been made to utilize bar code scanners in vending machines in order to try and detect unauthorized product in the machine. The Sanyo patent JP 4123194 and the Murphy Patent U.S. Pat. No. 5,390,711 both show some ways of trying to achieve this. The Sanyo patent shows bar code scanners at the loading point of a conventional beverage machine, whereby any unauthorized product would be detected at the time the product is loaded. This design may show some benefit in the case of the machine operator or route service loading person who simply tries to mistakenly put the wrong product in the machine. However, this design does little to actually prevent an intentional attempt by an operator or other person trying to put unauthorized product into the machine. This is due to the fact that if the detection of unauthorized products is occurring when the machine is being loaded, then that person could easily defeat the scanner in several ways. For one, the route person could cover up the bar code scanner with paper or another object while loading the machine. In another case, someone could simply have a piece of paper with an authorized bar code printed on it and by waving that over the bar code scanner, the machine will be tricked into vending unauthorized product. Referring to the patent by Murphy, the same problem is dealt with in a somewhat similar manner. By placing a bar code scanner at each spiral (product storage area) and with a relatively complex scanning mechanism, Murphy attempts to disable the machine from dispensing unauthorized product. Both Sanyo and Murphy require one Scanner or product identification system for each storage area (spiral or column of cans). This makes the practical usefulness of the designs very limited, since scanners are relatively expensive, delicate, and require accurate proximity to the code to be scanned in order to be effective. Murphy is an improvement over Sanyo, in one sense, in that it minimizes the chance of cheating by a route person since the verification of each code occurs before dispensing not at the time of loading. Murphy further shows that cheating attempts by covering over the scanner will shut down the operation of the machine.

A further disadvantage of both Sanyo and Murphy is the fact that bar code scanners and other ID devices are very sensitive to reading the code within a highly defined proximity. The prior art described, shows the scanners in a fixed position with the products to be scanned also in a highly defined position. This is also very impractical if the machine is going to be able to store and vend objects and articles of various sizes and shapes. Spiral machines are designed to hold various types of articles and packages in one spiral at the same time. Therefore, in order for a design such as Murphy's to work effectively, it would require a reliable identification of product every time.

Thus, some of the benefits of the present invention are as follows:
In the present invention there is described a multi-axis dispensing and product positioning mechanism. As product is removed from the storage areas the product or articles can be brought within proximity to (over) the Product ID (scanner). This design is far more efficient and an improvement over the prior art in several ways. For example, in the present invention there is only the need for as few as one product ID devices, since the dispensing mechanism carries the product to the ID device. Due to the cost and delicate nature of installing these types of devices in a machine of this cost, a dramatic cost savings and increased reliability are now achieved with the present invention.
Additionally, the product positioning system can manipulate the product to be scanned or identified until the control system gives back a signal confirming that a code has been read or permission to vend the product without a successful product ID.
The preferred embodiment of the present invention is described with a storage system of containers which hold product which is of uniform type. Additionally, in the preferred embodiment the product is merchandised using graphics on the outside of the machine in such a way that the end customer is usually not able to see the actual package or article to be dispensed. This type of merchandising also forces the operator to keep only one article type in any given bin and preprogrammed to at least one specific selection key. If the entire, or a large portion of the front of the machine comprises a single graphic, it further enhances this “enforcement” aspect of the invention.
While the present invention has a more reliable code reading method, the dedicated nature of the product storage bins (due to the graphics blocking a view of the products by the user) allows for a system which doesn't need to read 100% of the packages from any given container in order to determine that authorized product is generally being stored there. This enables the control system of the present embodiment to analyze the statistical data of the codes read or not read from a given container. With this analysis, the control system can determine whether it can allow a certain amount of acceptable error in the loading or the mis-loading of the product in the machine.
Using an algorithm, the control system can also detect whether product is perhaps being loaded into the machine in a position which makes the code unreadable. Regardless of the determination of the control system based on the desired strictness of the algorithm, the control system can then communicate the problem to an external computer, the digital display on the machine or simply to maintain the information in memory for use at a later time.
The scanner can also be used for traditional uses like inventory control and accountability, as well as time stamping for preventing sale of food product which is stale. In the present invention, if the control system determines that the article is not authorized, the control system can disable access to that product storage bins/area or disable the entire machine.

One problem facing vending machine operators is the control of the product selections placed in machines by their route personnel. Managers of vending companies often want machines merchandised in a specific way with a specific product selection plan (i.e., according to a plan-o-gram). They find it difficult to enforce a discipline in their route personnel who actually load the machines. The person actually loading or restocking the machine often tends to have his own preferences regarding the selections of products to be stocked in the machine.

Accordingly:

The preferred embodiment solves this problem by guaranteeing that the verified product specific sales data is captured and can be analyzed by the appropriate person.

Furthermore, the control system in the preferred embodiment has the ability to monitor and measure the effectiveness, accuracy, and discipline of a given route person in adhering to the prescribed merchandising plan. For example, the controls system can monitor

1) the time it takes between the service door opening and closing again, to indicate the total loading time that a driver spent at a machine,

2) the number of unauthorized products (if any) that the driver (route person) may have put in the machine, or

3) if the route person is filling all selections in the machine up to a sufficient capacity (this is achieved by measuring the known number of vends which occurred on a given product between the last fill servicing and the point at which a given selection is sold out and comparing that number to the known capacity that a given selection is capable of storing in a specific container).

There are several purposes that this employee performance data can be used for. For example, the performance data can be analyzed by software residing on the machine control system or at an external site, and this analysis can be used to calculate at least one performance measurement which can then be displayed or communicated to the route person at the machine or to a reporting system which can give a more detailed analysis. The analysis can, for example include showing the affect that the performance has had on revenue at a particular machine and can also show the employee the positive or negative impact that his performance at a given machine (or a conglomerated group of machines) has had on his/her potential commission or bonus incentives. In this way, monitoring machine performance, especially as it relates to the service record of a given employee, creates a powerful tool which can be used in order to educate, discipline and motivate the employee in an automated fashion. Every time that a service person stops at a machine to service it, he will automatically be seeing his performance rating on that machine (or a group of machines) based on an analysis of the machine's problem and fill levels since the last time that the route person was at that machine. In doing the analysis in this way, it gives feedback to the employee in a manner which links his incentives on a given machine to that machine. It is well known that incentives or punishment are most effective when they are linked to a specific action or inaction and that the measurement of the performance be given as soon as possible after the occurrence of the event that is being assessed.

Product Identification:

Description:

The apparatus will have product identification ( product ID device) means which could include but is not limited to at least one of a bar code scanner, a magnetic reading device, an optical image recognition device, a radio frequency ID device, a video camera, a digital camera. The product ID device (or multiple devices) is used in conjunction with the dispensing and storage apparatus and is capable of identifying the products which are being dispensed from the apparatus. Checking the product ID after it has been removed from the storage area or at least just before the product moves from it's storage area is preferable to checking the product during loading or at other times. This is true especially when the ID device is being utilized as described here, for the

If anyone tampers with a communication device such as a wireless device connected to the machine, the machine can be programmed to disable itself, and re-enable only with a proper authorization code.

The inventive techniques described herein can also be utilized for other applications such as leased business equipment and other types of machinery.

Additionally:

Gravity feed dispensing system where article “falls” past a centrally located article identification system
a. to enable:
   shut-down, full or partial
   for counting data and inventory control
   plan-o-gram enforceability for proper article layout by route driver as an incentive bonus with interior display and monitor of bonus program provided to route driver
      Business Method for Manufacture of Vending Machines
manufacturer desires to sell equipment at discount price, where price is tied to the end use of the equipment without leaving any money on the table, the equipment users can use the equipment, i.e., a Pay As You Vend (PAYV) system.

### PART III

For further description of various aspects of the invention, please refer to the following description.

### FIELD OF THE INVENTION

The invention relates to methods of doing business, and more particularly relates to methods of doing the business of machine vending with a third party. In its most immediate sense, the invention relates to methods of doing machine vending using a computerized vending machine, or CVM, such as is disclosed in PART I herein.

The third party issues an authorization code that prevents a computerized vending machine (“CVM”) from being shut down automatically, or a de-authorization code that causes the CVM to be at least partially shut down. Use of such codes makes it more prudent for parties to enter into contracts that were previously impractical or susceptible of abuse by dishonest vending machine operators.

### BACKGROUND OF SEVERAL ASPECTS OF THE INVENTION

Existing methods of doing business using vending machines, and indeed existing contractual relationships that relate to such machines, are based upon a conventional vending machines of the self-standing type. In such methods and relationships, an “operator” of the machine (this may be an owner or lessee of the machine) sites the machine at a particular location controlled by a person having an interest in the real property at that location (the “landlord”). (For the purposes of this invention, the landlord may own the property, may be a lessee, or a real estate agent. And, the landlord need not be different from the “operator”.) The operator contracts with a seller of goods (e.g. the “manufacturer” of snack foods, which usually is but need not necessarily be different from the operator or the landlord) that are loaded into the machine. When a purchaser purchases goods from the machine, he or she makes a payment to the machine and gets the goods in return. The operator periodically collects the money and pays the landlord and the manufacturer. If the owner is a lessee or has purchased the machine with financing provided by a lender, then the owner will also pay the lender (e.g. a bank) from the money collected from the machine.

Heretofore, the contractual relationships between these parties have been independent of the actual operations carried out by the machine. For example, the landlord will charge the operator rent based e.g. upon the location and size of the place where the machine is located and the cost of providing electricity to operate the machine. So, too, the lender will charge the operator a sum that is related to the amount loaned to the operator and to whatever interest rate currently applies. Likewise, the manufacturer will charge the operator a price related to the quantity and nature of the goods the operator elects to purchase.

Such relatively simple contracts are different from those used in analogous retail situations. For example, a store in a shopping center will conventionally pay the landlord a negotiated percentage of its sales. Such a pay-as-you-go arrangement can be highly beneficial for both parties, since they can share the risks and rewards of the business and can adjust the share to correspond to e.g. the financial status of the tenant.

Such arrangements have not been practical for vending machines. This is because such machines must be physically visited by persons who e.g. remove cash from them, and such persons cannot easily be supervised by third parties such as banks or landlords. Furthermore, operators can and do change the product offerings of the machines to better match the wants of the persons who purchase items from them, and it would be very difficult for e.g. a bank or a landlord to know exactly what goods were loaded into a particular machine at any particular time.

Operators, landlords, manufacturers, and lenders would all benefit from contractual relationships wherein payments related to vending machines would depend upon actual operations carried out by the machine, i.e. would depend upon e.g. the number, types, and prices of items sold from the machine, the time of day that the machine was most often used, sales data collected by the machine, etc.

Accordingly, an object of the invention is to provide a method of doing business wherein persons could receive payments based on actual operations carried out a vending machine.

Another object of the invention is to provide a method of doing business wherein a person who is in physical possession of such a machine may be deprived of some or all of the economic benefits of the machine without the need to physically take the machine away from the person in possession of it.

### SUMMARY OF SEVERAL ASPECTS OF THE INVENTION

The invention proceeds from the realization that a CVM can be provided with computer intelligence sufficient to wholly or partly reversibly disable operation of the CVM, or to re-enable operation of the CVM again, by timely inputting an authorization code or a deauthorization code, and that the use of such a code will engender confidence in a third party that he or she will be properly paid. For example, let it be assumed that a bank finances the operator's purchase of a CVM and the operator pays the bank every 30 days. The CVM will be programmed to automatically shut down at 30 day intervals. If the operator actually pays the bank, then the bank will provide the operator with an authorization code that the operator can input to the CVM to keep the machine operating after the 30 days has passed. If the operator does not pay the bank, then the CVM will automatically become disabled, and the operator will derive no economic benefit from it. The lack of such economic benefit will then serve as an incentive for the operator to pay the bank. And, the bank need not take physical possession of the CVM to achieve this result. The bank can wait until it is convenient to take physical possession.

Alternatively, a lessor may lease the operator a CVM in accordance with a contract under which the operator pays the lessor 10% of the sales volume from the CVM every 30 days. The CVM can then be programmed to register the sales volume over each 30 day period and then to shut down automatically unless the operator inputs an authorization code provided by the lessor.

In yet another alternative, let it be assumed that a landlord provides a large space for a bank of CVMs, purchases or leases the CVMs and sites them there, and engages an operator to run the CVMs in accordance with a contract under which the operator must pay the landlord 40% of the sales of the CVMs. After some time, the landlord checks the sales of the CVMs and finds that the operator has been underpaying. The landlord can then input a deauthorization code to the CVMs to shut them down until the operator has settled its accounts with the landlord.

In still another alternative, let it be assumed that a landlord provides a large space filled with CVMs, hires staff to service the machines, and sets different manufacturers in competition with each other to have their goods sold from the CVMs. (In this example, the landlord is also the owner. As stated above, the landlord and owner, just like the owner and manufacturer, the manufacturer and landlord, etc., can be the same or different.) Each manufacturer contracts with the landlord to pay the landlord a rebate based on sales of the manufacturer's goods. If the manufacturer is late in paying the rebate, the landlord can input a deauthorization code to prevent that manufacturer's goods from being sold until the manufacturer has settled accounts with the landlord.

One particularly advantageous embodiment of the invention is specifically adapted for use in a very common relationship between a manufacturer and an operator. In this common relationship, the manufacturer provides a custom-decorated vending machine to the operator. The vending machine is decorated with e.g. the manufacturer's logo and/or housemark, indicating that COCA-COLA® or PEPSI® etc. can be purchased from the vending machine. Naturally, when such a relationship exists, the manufacturer and operator enter into contract wherein the operator is obliged to refrain from stocking the vending machine with goods made by a competing manufacturer.

In the CVM disclosed in at least one of the above-referenced patent applications, the CVM can be loaded with different types of goods and the front of the CVM has first and second regions. The manufacturer can supply the CVM with the manufacturer's logo, housemark etc. in the first region, and the operator can provide artwork for other goods in the second region.

With such an arrangement, the operator and manufacturer can contract to provide e.g. that at least 80% (measured by units, sales in dollars, or by whatever criterion the parties negotiate and verified by e.g. a barcode scanner in the CVM) of the goods sold from the CVM will be manufactured by the manufacturer, while allowing the operator the freedom to select the other 20% (for which the operator can put corresponding artwork in the second region). If in actual operation of the CVM the negotiated percentage is not achieved, then the CVM can be programmed to indicate that selected goods are unavailable, preventing them from being sold and thereby increasing the percentage to the negotiated percentage.

In the CVM disclosed in at least one of the above-referenced patent applications, the CVM has a communications port permitting the CVM to be accessed by e.g. the Internet. In an especially advantageous embodiment of the invention, an exclusive contract is established with a data management company that communicates with the CVM through the port and serves as a gateway for other firms that require such communication. The data management company can convey information about e.g. products purchased and dates and times of purchases to firms that can use such information and can also serve as a trusted intermediary so that the CVM is not subjected to conflicting authorization and deauthorization codes from different parties.

In accordance with yet another advantageous aspect of the invention, the third party is paid at least partially by receipt of data. For example, a food manufacturer may produce a new food/snack item and may lack information about consumer acceptance of the item and the times and circumstances under which consumers are likely to purchase it. In such circumstances, the manufacturer may provide the item to the operator at no charge, but rather in accordance with a contract under which the operator must supply information regarding sales of the item at various prices and at various times of day and days of the week. Such information can aid the manufacturer to test-market the new item and to determine consumer acceptance of the item at various price points. If the manufacturer does not receive the information, the manufacturer can either withhold an authorization code or generate a deauthorization code and thereby prevent the operator from deriving a financial benefit by selling the item.

Alternatively, the third party may be paid at least partially by receipt of contract rights. For example, a manufacturer may produce a new food/snack item and may purchase from the operator the right to have the item distributed from all the operator's CVMs, but at various price points so as to conduct a controlled market test.

These different forms of payments need not be mutually exclusive; a third party may for example receive a combination of currency and data.

### DETAILED DESCRIPTION OF SEVERAL ASPECTS OF PREFERRED EMBODIMENTS OF THE INVENTION

CVMs suitable for the herein-disclosed inventions are disclosed in PART I herein, as well as the below-referenced pending patent applications, the entire disclosures of which are incorporated herein as if fully set forth, including the drawings.
1) PCT/US01/16916, filed May 23, 2001, entitled METHOD AND APPARATUS FOR ARTICLE CONTACT DETECTION IN AN ARTICLE HANDLING DEVICE;
2) PCT/US01/16847, filed May 23, 2001, entitled METHOD AND APPARATUS FOR STORING ARTICLES FOR USE WITH AN ARTICLE HANDLING DEVICE;
3) PCT/US01/16846, filed May 23, 2001, entitled METHOD AND APPARATUS FOR HOSE STORAGE IN AN ARTICLE HANDLING DEVICE; and
4) PCT/US01/16853, filed May 23, 2001, entitled METHOD AND APPARATUS FOR INCLUDING ARTICLE IDENTIFICATION IN AN ARTICLE HANDLING DEVICE.

A proper understanding of this invention requires a reconsideration of business arrangements that are traditionally made with respect to vending from machines. In one traditional arrangement, an operator buys or leases a machine, installs it at a landlord's premises, and pays the landlord rent (which may be a commission percentage). In such an arrangement, the landlord must trust the honesty of the operator. While it is possible for the landlord to audit the operator's financial records, the vending business is presently a cash-based business and no party to a vending contract can be sure that all machine receipts are in fact recorded on the operator's books.

In another traditional arrangement, a food or beverage manufacturer engages a vending machine manufacturer to make machines having product-specific graphics (so that a consumer can know e.g. that the machine dispenses PEPSI® or FRITOS®). This custom-labeled machine is then sold or leased to an operator. In such an arrangement, the food or beverage manufacturer seeks to prevent the operator from selling products other than those for which the custom-labeled machine was originally intended, and most of the time the food manufacturer must simply trust to the honesty of the operator. In some exceptional instances, such machines can read the barcode information on the goods loaded into them, and self-destruct if the goods are not those the machine has been programmed to expect, but this is an extreme and wasteful measure.

These traditional arrangements are necessarily simple and unsophisticated because inter alia it is not feasible for anyone other than the operator to interact with the vending machine.

However, a CVM of the types mentioned above has sufficient intelligence to “know” e.g. the items stored in it, the dates, times, and prices of sales, the dates and times it is serviced and the identity of the person(s) servicing it, etc. (For example, a CVM can use a laser scanner to read the barcode on an item stored in it and this information can be matched with information stored in the CVM.) And, information regarding the contents of the machine and the particulars of sales from the machine can be easily stored in the machine and outputted to a computer (e.g. a laptop or a handheld in the hands of a service person) or sent to a remote computer via a communications port (that connects e.g. to the Internet). This makes it practical for persons other than the operator to have accurate information about the actual operations carried out by the CVM. This in turn makes it practical for parties to make contracts that would have been imprudent using older vending machine technology.

For example, most landlords would have been unwilling to purchase banks of vending machines for use in e.g. company cafeterias. This is because the landlord would likely have to contract with an operator company to stock and service the machines and it would be very difficult for the landlord to be confident that the operator was not skimming cash that properly belonged to the landlord. However, it would be feasible for a landlord to purchase or lease a bank of CVMs and to contract with a third party operator to stock and service them, because the landlord would have recourse to the actual operations carried out by the CVM as a check on the honesty of the operator. In other words, CVMs can practically be owned or leased by persons other than operators, and CVMs make it practical to unbundle functions that formerly would have been carried out by operators alone. Hence, it would be practical (although not necessarily profitable) for an operator to contract with a third party to stock and service CVMs that are remote from the operator's main geographical area.

Hence, the availability of highly sophisticated CVMs makes it possible for parties to consider many different types of contracts that would have been considered imprudent using older vending machines. (As used herein, “contract” is used in its most general sense. The contract need not be written out.) In general, each party to such a contracts will likely fall into one or more of the following categories:
a manufacturer of items dispensed from the CVM;
a person having an ownership interest (e.g. title, lease, security interest, right to operate) in the CVM;
a person having an interest (e.g. title, lease, possessory interest) in real property where the CVM is located;
a person having a legal right to remove money from the CVM;
a person having a legal right to load goods into the CVM; and
a person having a legal right to communicate with the CVM via its communications port.

Although CVMs make it practical for parties to enter into different type of vending contracts, they still require the ability to enforce self-help measures if their contract partner does not adhere to the provisions of the contract. Usually but by no means always the self-help measure is the entire or partial shutdown of the CVM. In many instances, the CVM will shut down, totally or partially, by the automatic generation of a shut-down signal. For example, the CVM might shut down automatically upon:
a) passage of a predetermined period of time (e.g. a month);
b) movement of the CVM, or excessively frequent movement of the CVM;
c) passage of a predetermined period of time between servicings (to e.g. prevent stale goods in the CVM from being dispensed);
d) excessive sales of a non-branded item in a CVM primarily intended for sales of branded items; or
e) sale of a predetermined sales volume of goods, or of a predetermined sales volume within a predetermined period of time.

To prevent such a shutdown, or to reverse such a shutdown if one has already occurred, an authorization code is input to the CVM. Hence, in accordance with an exemplary preferred embodiment of the invention, a bank may contract with an operator to finance the operator's purchase or lease of a CVM. The CVM is programmed to shut down at noon on the last day of each month unless an authorization code is previously input to the CVM. If the bank receives payment, it generates an authorization code that may be input to the CVM and that will prevent the next scheduled shutdown from taking place. The authorization code may be manually input to the CVM by the operator, or electronically input to the CVM (as via the Internet) if the CVM has a communications port that permits this.

The shutdown of the CVM need not necessarily prevent all operation of the CVM. For example, the CVM disclosed in at least one of the above-referenced patent applications can distinguish between different goods loaded into it. It is possible, for example, to disable the CVM from dispensing only one or two items that have been loaded into it, and to continue to dispense all the others until dispensing of the disabled goods is re-permitted by input of an authorization code.

In accordance with another aspect of the invention, the CVM does not automatically shut down in the absence of a timely input authorization code. Rather, the CVM continues to operate until it is wholly or partially disabled upon receipt of a de-authorization code. This would be preferred when, for example, each party recognizes that the other is a financially responsible entity that can ordinarily be depended upon to meet its financial obligations. In such a context, shutdown should properly be an extraordinary remedy.

Accordingly, in accordance with this aspect of the invention, the third party issues the de-authorization code (or causes it to be issued) and causes it to be input to the CVM, which in turn causes the CVM to at least partially shut down.

In yet another preferred embodiment of the invention, a data management company is engaged to serve as an electronic gateway having the exclusive right to communicate with the CVM through the communications port. This embodiment may be particularly advantageous when an operator enters into a contracts under which a plurality of manufacturers supply items for a single machine. For example, if a CVM is capable of vending 40 items, the data management company may (acting as agent for the operator) contract with five different manufacturers, each supplying 8 items to be sold from the CVM. The data management company would e.g. administer the collection and input of the necessary authorization and deauthorization codes, would prevent the CVM from receiving contradictory codes, and would package and distribute data from the CVM for the benefit of the operator. Although at least one preferred embodiment of the invention has been described above, this description is not limiting and is only exemplary

1. A method of operating a vending machine after it has been placed in service and is under the control of an operator of the vending machine, the vending machine having a usage meter which determines usage of the machine based on accumulation of a given operational parameter of the machine while it is in the service of the operator, comprising:
preprogramming a substantially unalterable control portion of the machine before the machine is under the control of the operator, so as to allow the machine to operate while under the control of the operator until a predetermined amount of the given operational parameter has been accumulated from a starting value,
comparing the accumulated amount of the given operational parameter with the predetermined amount, and
when said comparing indicates that the accumulated amount has equaled or exceeded the predetermined amount, said control portion either inhibits further operation of at least a portion of the machine, or initiates a procedure which will inhibit further operation of at least a portion of the machine.

2. The method of claim 1, wherein,
the usage meter is reset to the starting value only if the control portion of the machine receives an authorization code from a source; and
said source does not provide the authorization code unless the source has first received from the vending machine the current amount accumulated by its usage meter.

3. The method of claim 2, further including:
entering into at least one contractual obligation with at least one entity concerning sales of goods from the vending machine; and
agreeing with the at least one entity that (i) the vending machine will initially be enabled to dispense the goods, and (ii) the vending machine may be at least partially disabled from dispensing at least some of the goods by withholding said authorization code after the control portion of the machine has indicated that the accumulated amount has equaled or exceeded the predetermined amount.

4. The method of claim 3, wherein an authorized third party receives data concerning the sale of goods from the vending apparatus, determines whether the at least one contractual obligation with the at least one entity has been satisfied based at least in part on the received data, and makes the authorization code available to the vending apparatus if the at least one contractual obligation has been at least one of satisfied and waived.

5. The method of claim 3, wherein the contractual obligation comprises vending of only authorized articles only from the machine, and sale of less than a predetermined accumulated value of unauthorized goods comprises the contractual obligation.

6. The method of claim 2, further including a remote site for controlling at least a portion of the operation of a plurality of said vending machines, said remote site,
maintaining information about the operational parameters for all of the vending machines under a common account;
storing in a memory a unique code which is assigned to each of the vending machines, which code is also stored in a memory of each respective vending machine, and
receiving usage data from each of the vending machines which has been encoded by the vending machines using the unique code.

7. The method of claim 6, wherein,
in response to the remote site receiving usage data from a given vending machine, the remote site provides to the given vending machine an encoded reply code; and
wherein the reply code requires the unique code of the given vending machine in order to be decoded, and thereby reset the usage meter of the given vending machine to the starting value.

8. The method of claim 6, further including:
receiving at the remote site said usage data via one of an Internet connection, a wireless or wired telephonic communication link, or a manual input.

9. A vending apparatus, comprising:
at least one storage area being operable to store packaged goods for sale;
at least one retrieving device operable to retrieve the goods from the storage area and to dispense the goods from the vending apparatus;
a processing unit which includes a substantially unalterable program which is installed therewith before release of control of the vending apparatus to an operator thereof, which program causes said vending apparatus to be operable while under the control of the operator so as to,
(i) permit the dispensing of goods from the vending apparatus for an interval,
(ii) partially disable the vending apparatus from dispensing at least some of the goods at an end of the interval.

10. A vending apparatus of claim 9, wherein said vending apparatus is operable while under the control of the operator so as to,
(iii) not at least partially disable the vending apparatus at the end of the interval if a continuation code is received by the vending apparatus before the end of the interval,

11. A vending apparatus of claim 9, wherein the interval represents at least one of:
(i) one or more predefined periods of time;
(ii) one or more predefined numbers of vends of goods from the vending apparatus;
(iii) one or more predefined quanta of sales by the vending apparatus.

12. The apparatus of claim 9, wherein a goods identification scanning device of the vending apparatus is used to obtain the usage information.

13. A vending apparatus of claim 10, wherein the processing unit is further operable to at least one of reset and modify the interval in response to the vending apparatus receiving the continuation code.

14. The apparatus of claim 10, further including a communications unit operable to connect the vending apparatus to a communications network, such that the continuation code may be input into the vending apparatus over the communications network.

15. The apparatus of claim 10, wherein a remote processing unit located remotely from the vending apparatus is operable to determine that usage data from the vending apparatus are authentic prior to making the continuation code available to the vending apparatus.

16. A method of doing business with a third party wherein the third party is entitled to receive payment based upon actual operations carried out by a computerized vending machine (“CVM”), the CVM having means for disabling itself from dispensing goods unless an authorization code is timely input thereto, comprising the following steps:
contracting with the third party to pay the third party based upon actual operations carried out by the CVM;
generating an authorization code under authority of the third party; and
inputting the authorization code to the CVM.

17. The method of claim 16, wherein the third party is selected from at least one of the following categories:
a seller of goods dispensed from the CVM;
a person having an ownership interest in the CVM;
a person having an interest in real property where the CVM is located;
a person having a legal right to remove money from the CVM; and
a person having a legal right to load goods into the CVM.

18. The method of claim 16, wherein the CVM has a communications port enabling remote electronic communication with the CVM, and wherein the third party is selected from at least one of the following categories:
a manufacturer of items dispensed from the CVM;
a person having an ownership interest in the CVM;
a person having an interest in real property where the CVM is located;
a person having a legal right to remove money from the CVM;
a person having a legal right to load goods into the CVM; and
a person having a legal right to communicate with the CVM via the communications port.

19. The method of claim 92, wherein the payment to the third party is selected to include at least one of the following categories:
a currency payment to the third party;
a transfer of data to the third party; and
a transfer of contract rights to the third party.

20. The method of claim 18, wherein the communication ports is adapted for communication via at least one of the Internet or via a portable computer.
